(19) United States
(12) Patent Application Publication
(10) Pub. No.: US 2026/0222232 A1
(43) Pub. Date: Jul. 30, 2026

(54) BLOCKCHAIN-BASED NETWORK ADDRESS

(71) Applicant: NCHAIN LICENSING AG, Zug (CH)

(72) Inventors: Mathieu DUCROUX, London (GB); Wei ZHANG, London (GB)

(21) Appl. No.: 19/132,739

(22) PCT Filed: Nov. 24, 2023
(86) PCT No.: PCT/EP2023/083070

§ 371 Date: May 23, 2025

(30) Foreign Application Priority Data
Nov. 28, 2022 (GB) 2217827.1
Feb. 13, 2023 (GB) 2302010.0

(51) Int. Cl. H04L 9/00; H04L 9/32; H04L 61/5007; H04L 101/659

(52) U.S. Cl. CPC H04L 9/50; H04L 9/3236; H04L 61/5007; H04L 2101/659

(57) ABSTRACT

A computer-implemented method of generating a network address, wherein the method comprises: generating a first blockchain transaction, wherein the first transaction comprises a first data item based on a public key; and generating a first network address based on one or more second data items related to the first blockchain transaction.

### CROSS REFERENCE TO RELATED APPLICATIONS

This application is the U.S. National Stage of International Application No. PCT/EP2023/083070 filed on Nov. 24, 2023, which claims the benefit of United Kingdom Patent Application No. 2217827.1, filed on Nov. 28, 2022, and United Kingdome Patent Application No. 2302010.0, filed on Feb. 13, 2023, the contents of which are all incorporated herein by reference in their entireties.

### TECHNICAL FIELD

The present disclosure relates to generating a network address (e.g. an IP address, such as an IPv6 address) based on information relating to the blockchain.

### BACKGROUND

A blockchain refers to a form of distributed data structure, wherein a duplicate copy of the blockchain is maintained at each of a plurality of nodes in a distributed peer-to-peer (P2P) network (referred to below as a “blockchain network”) and widely publicised. The blockchain comprises a chain of blocks of data, wherein each block comprises one or more transactions. Each transaction, other than so-called “coinbase transactions”, points back to a preceding transaction in a sequence which may span one or more blocks going back to one or more coinbase transactions. Coinbase transactions are discussed further below. Transactions that are submitted to the blockchain network are included in new blocks. New blocks are created by a process often referred to as “mining”, which involves each of a plurality of the nodes competing to perform “proof-of-work”, i.e. solving a cryptographic puzzle based on a representation of a defined set of ordered and validated pending transactions waiting to be included in a new block of the blockchain. It should be noted that the blockchain may be pruned at some nodes, and the publication of blocks can be achieved through the publication of mere block headers.

The transactions in the blockchain may be used for one or more of the following purposes: to convey a digital asset (i.e. a number of digital tokens), to order a set of entries in a virtualised ledger or registry, to receive and process timestamp entries, and/or to time-order index pointers. A blockchain can also be exploited in order to layer additional functionality on top of the blockchain. For example blockchain protocols may allow for storage of additional user data or indexes to data in a transaction. There is no pre-specified limit to the maximum data capacity that can be stored within a single transaction, and therefore increasingly more complex data can be incorporated. For instance this may be used to store an electronic document in the blockchain, or audio or video data.

Nodes of the blockchain network (which are often referred to as “miners”) perform a distributed transaction registration and verification process, which will be described in more detail later. In summary, during this process a node validates transactions and inserts them into a block template for which they attempt to identify a valid proof-of-work solution. Once a valid solution is found, a new block is propagated to other nodes of the network, thus enabling each node to record the new block on the blockchain. In order to have a transaction recorded in the blockchain, a user (e.g. a blockchain client application) sends the transaction to one of the nodes of the network to be propagated. Nodes which receive the transaction may race to find a proof-of-work solution incorporating the validated transaction into a new block. Each node is configured to enforce the same node protocol, which will include one or more conditions for a transaction to be valid. Invalid transactions will not be propagated nor incorporated into blocks. Assuming the transaction is validated and thereby accepted onto the blockchain, then the transaction (including any user data) will thus remain registered and indexed at each of the nodes in the blockchain network as an immutable public record.

The node who successfully solved the proof-of-work puzzle to create the latest block is typically rewarded with a new transaction called the “coinbase transaction” which distributes an amount of the digital asset, i.e. a number of tokens. The detection and rejection of invalid transactions is enforced by the actions of competing nodes who act as agents of the network and are incentivised to report and block malfeasance. The widespread publication of information allows users to continuously audit the performance of nodes. The publication of the mere block headers allows participants to ensure the ongoing integrity of the blockchain.

In an “output-based” model (sometimes referred to as a UTXO-based model), the data structure of a given transaction comprises one or more inputs and one or more outputs. Any spendable output comprises an element specifying an amount of the digital asset that is derivable from the proceeding sequence of transactions. The spendable output is sometimes referred to as a UTXO (“unspent transaction output”). The output may further comprise a locking script specifying a condition for the future redemption of the output. A locking script is a predicate defining the conditions necessary to validate and transfer digital tokens or assets. Each input of a transaction (other than a coinbase transaction) comprises a pointer (i.e. a reference) to such an output in a preceding transaction, and may further comprise an unlocking script for unlocking the locking script of the pointed-to output. So consider a pair of transactions, call them a first and a second transaction (or “target” transaction). The first transaction comprises at least one output specifying an amount of the digital asset, and comprising a locking script defining one or more conditions of unlocking the output. The second, target transaction comprises at least one input, comprising a pointer to the output of the first transaction, and an unlocking script for unlocking the output of the first transaction.

In such a model, when the second, target transaction is sent to the blockchain network to be propagated and recorded in the blockchain, one of the criteria for validity applied at each node will be that the unlocking script meets all of the one or more conditions defined in the locking script of the first transaction. Another will be that the output of the first transaction has not already been redeemed by another, earlier valid transaction. Any node that finds the target transaction invalid according to any of these conditions will not propagate it (as a valid transaction, but possibly to register an invalid transaction) nor include it in a new block to be recorded in the blockchain.

An alternative type of transaction model is an account-based model. In this case each transaction does not define the amount to be transferred by referring back to the UTXO of a preceding transaction in a sequence of past transactions, but rather by reference to an absolute account balance. The current state of all accounts is stored by the nodes separate to the blockchain and is updated constantly.

### SUMMARY

A network address, such as an internet protocol (IP) address, is used to identify and/or locate a node on a network. One type of network address is the internet protocol version 6 (IPv6) address. A pivotal feature of IPv6 is its plug-and-play capability that enables newly set up systems to integrate seamlessly into networks. One technique to achieve this is called Cryptographically Generated Address (CGA). CGA was introduced as part of the SEcure Neighbour Discovery (SEND) protocol to enable nodes to join a subnet and locally generate their own IPv6 address. Addresses are bound to the public key of a node using a cryptographic one-way hash function. Ultimately, CGA provides a secure way for nodes to prove they are controlling an advertised IPv6 address without relying on any security infrastructure. The aim is to prevent spoofing and Denial-of-Service (DoS) attacks that protocols such as the Neighbour Discovery Protocol (NDP) suffer from.

Despite its benefits, the practical deployment of CGA has been very limited. This is due to complex cryptographic algorithms used during address generation which have a serious effect on its performance. This issue becomes particularly problematic in Mobile IPv6 (MIPv6) networks that usually involve low-end nodes with limited computational power. Delays have to be minimised to preserve the quality of real-time and interactive applications. In practice, this means that operations like handovers should be completed within a few hundred milliseconds.

There is therefore a need to be able to generate network addresses quickly and efficiently (e.g. IPv6 addresses) with good security, especially for low-end devices.

According to one aspect disclosed herein, there is provided a computer-implemented method of generating a network address, wherein the method comprises: generating a first blockchain transaction, wherein the first transaction comprises a first data item based on a public key; and generating a first network address based on one or more second data items related to the first blockchain transaction.

According to another aspect disclosed herein, there is provided a computer-implemented method of verifying a network address, wherein the method comprises: obtaining a target public key, a target network address, and a first blockchain transaction comprising a first data item; verifying that the first data item is based on the target public key; obtaining one or more second data items related to the first blockchain transaction; generating a candidate network address based on the one or more second data items; and verifying that the target network address matches the candidate network address.

Embodiments provided blockchain-based (or “blockchain-certified”) network addresses which are simple to generate and inherit the security of the blockchain itself. For instance, embodiments may be used to generate so-called Blockchain-Certified IPv6 Addresses (BCA). Similarly to CGA, BCA defines a decentralised mechanism to securely bind public keys to IPv6 addresses. The binding is secured by leveraging the work done by the blockchain network. The implication is that nodes can generate IPv6 address without doing any complex cryptographic operations, thereby making BCA much more practical for lightweight nodes than CGA. Since the blockchain network consists of large pools of processing units, the binding between the address and the public key is much more secure. Spoofing attacks that are possible for a well-equipped attacker in CGA become completely out-of-scope in BCA. Ultimately, BCA can serve as a more secure and efficient replacement to CGA.

Whilst embodiments are primarily described in terms of IPv6 addresses by way of example, in general the embodiments may be used to generate any type of network address.

### BRIEF DESCRIPTION OF THE DRAWINGS

To assist understanding of embodiments of the present disclosure and to show how such embodiments may be put into effect, reference is made, by way of example only, to the accompanying drawings in which:

FIG. 1 is a schematic block diagram of a system for implementing a blockchain,

FIG. 2 schematically illustrates some examples of transactions which may be recorded in a blockchain,

FIG. 3 schematically illustrates the format of a IPv6 address,

FIG. 4 schematically illustrates the flow of the CGA generation algorithm, and

FIG. 5 is a schematic block diagram of a system for generating blockchain-based network addresses.

### DETAILED DESCRIPTION OF EMBODIMENTS

### 1. Example System Overview

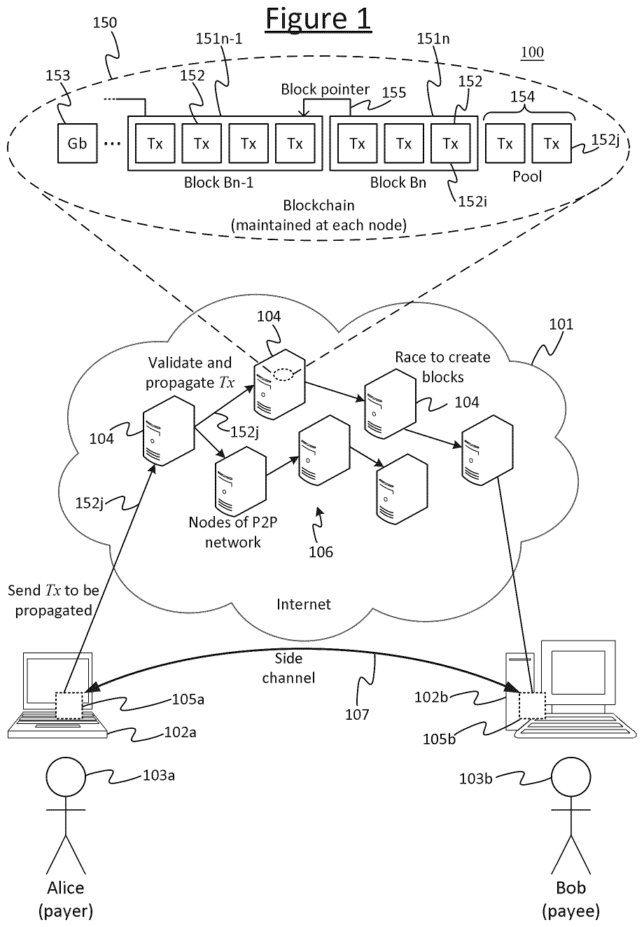

FIG. 1 shows an example system 100 for implementing a blockchain 150. The system 100 may comprise a packet-switched network 101, typically a wide-area internetwork such as the Internet. The packet-switched network 101 comprises a plurality of blockchain nodes 104 that may be arranged to form a peer-to-peer (P2P) network 106 within the packet-switched network 101. Whilst not illustrated, the blockchain nodes 104 may be arranged as a near-complete graph. Each blockchain node 104 is therefore highly connected to other blockchain nodes 104.

Each blockchain node 104 comprises computer equipment of a peer, with different ones of the nodes 104 belonging to different peers. Each blockchain node 104 comprises processing apparatus comprising one or more processors, e.g. one or more central processing units (CPUs), accelerator processors, application specific processors and/or field programmable gate arrays (FPGAs), and other equipment such as application specific integrated circuits (ASICs). Each node also comprises memory, i.e. computer-readable storage in the form of a non-transitory computer-readable medium or media. The memory may comprise one or more memory units employing one or more memory media, e.g. a magnetic medium such as a hard disk; an electronic medium such as a solid-state drive (SSD), flash memory or EEPROM; and/or an optical medium such as an optical disk drive.

The blockchain 150 comprises a chain of blocks of data 151, wherein a respective copy of the blockchain 150 is maintained at each of a plurality of blockchain nodes 104 in the distributed or blockchain network 106. As mentioned above, maintaining a copy of the blockchain 150 does not necessarily mean storing the blockchain 150 in full. Instead, the blockchain 150 may be pruned of data so long as each blockchain node 150 stores the block header (discussed below) of each block 151. Each block 151 in the chain comprises one or more transactions 152, wherein a transaction in this context refers to a kind of data structure. The nature of the data structure will depend on the type of transaction protocol used as part of a transaction model or scheme. A given blockchain will use one particular transaction protocol throughout. In one common type of transaction protocol, the data structure of each transaction 152 comprises at least one input and at least one output. Each output specifies an amount representing a quantity of a digital asset as property, an example of which is a user 103 to whom the output is cryptographically locked (requiring a signature or other solution of that user in order to be unlocked and thereby redeemed or spent). Each input points back to the output of a preceding transaction 152, thereby linking the transactions.

Each block 151 also comprises a block pointer 155 pointing back to the previously created block 151 in the chain so as to define a sequential order to the blocks 151. Each transaction 152 (other than a coinbase transaction) comprises a pointer back to a previous transaction so as to define an order to sequences of transactions (N.B. sequences of transactions 152 are allowed to branch). The chain of blocks 151 goes all the way back to a genesis block (Gb) 153 which was the first block in the chain. One or more original transactions 152 early on in the chain 150 pointed to the genesis block 153 rather than a preceding transaction.

Each of the blockchain nodes 104 is configured to forward transactions 152 to other blockchain nodes 104, and thereby cause transactions 152 to be propagated throughout the network 106. Each blockchain node 104 is configured to create blocks 151 and to store a respective copy of the same blockchain 150 in their respective memory. Each blockchain node 104 also maintains an ordered set (or “pool”) 154 of transactions 152 waiting to be incorporated into blocks 151. The ordered pool 154 is often referred to as a “mempool”. This term herein is not intended to limit to any particular blockchain, protocol or model. It refers to the ordered set of transactions which a node 104 has accepted as valid and for which the node 104 is obliged not to accept any other transactions attempting to spend the same output.

In a given present transaction 152j, the (or each) input comprises a pointer referencing the output of a preceding transaction 152i in the sequence of transactions, specifying that this output is to be redeemed or “spent” in the present transaction 152j. Spending or redeeming does not necessarily imply transfer of a financial asset, though that is certainly one common application. More generally spending could be described as consuming the output, or assigning it to one or more outputs in another, onward transaction. In general, the preceding transaction could be any transaction in the ordered set 154 or any block 151. The preceding transaction 152i need not necessarily exist at the time the present transaction 152j is created or even sent to the network 106, though the preceding transaction 152i will need to exist and be validated in order for the present transaction to be valid. Hence “preceding” herein refers to a predecessor in a logical sequence linked by pointers, not necessarily the time of creation or sending in a temporal sequence, and hence it does not necessarily exclude that the transactions 152i, 152j be created or sent out-of-order (see discussion below on orphan transactions). The preceding transaction 152i could equally be called the antecedent or predecessor transaction.

The input of the present transaction 152j also comprises the input authorisation, for example the signature of the user 103a to whom the output of the preceding transaction 152i is locked. In turn, the output of the present transaction 152j can be cryptographically locked to a new user or entity 103b. The present transaction 152j can thus transfer the amount defined in the input of the preceding transaction 152i to the new user or entity 103b as defined in the output of the present transaction 152j. In some cases a transaction 152 may have multiple outputs to split the input amount between multiple users or entities (one of whom could be the original user or entity 103a in order to give change). In some cases a transaction can also have multiple inputs to gather together the amounts from multiple outputs of one or more preceding transactions, and redistribute to one or more outputs of the current transaction.

According to an output-based transaction protocol such as bitcoin, when a party 103, such as an individual user or an organization, wishes to enact a new transaction 152j (either manually or by an automated process employed by the party), then the enacting party sends the new transaction from its computer terminal 102 to a recipient. The enacting party or the recipient will eventually send this transaction to one or more of the blockchain nodes 104 of the network 106 (which nowadays are typically servers or data centres, but could in principle be other user terminals). It is also not excluded that the party 103 enacting the new transaction 152j could send the transaction directly to one or more of the blockchain nodes 104 and, in some examples, not to the recipient. A blockchain node 104 that receives a transaction checks whether the transaction is valid according to a blockchain node protocol which is applied at each of the blockchain nodes 104. The blockchain node protocol typically requires the blockchain node 104 to check that a cryptographic signature in the new transaction 152j matches the expected signature, which depends on the previous transaction 152i in an ordered sequence of transactions 152. In such an output-based transaction protocol, this may comprise checking that the cryptographic signature or other authorisation of the party 103 included in the input of the new transaction 152j matches a condition defined in the output of the preceding transaction 152i which the new transaction spends (or “assigns”), wherein this condition typically comprises at least checking that the cryptographic signature or other authorisation in the input of the new transaction 152j unlocks the output of the previous transaction 152i to which the input of the new transaction is linked to. The condition may be at least partially defined by a script included in the output of the preceding transaction 152i. Alternatively it could simply be fixed by the blockchain node protocol alone, or it could be due to a combination of these. Either way, if the new transaction 152j is valid, the blockchain node 104 forwards it to one or more other blockchain nodes 104 in the blockchain network 106. These other blockchain nodes 104 apply the same test according to the same blockchain node protocol, and so forward the new transaction 152j on to one or more further nodes 104, and so forth. In this way the new transaction is propagated throughout the network of blockchain nodes 104.

In an output-based model, the definition of whether a given output (e.g. UTXO) is assigned (or “spent”) is whether it has yet been validly redeemed by the input of another, onward transaction 152j according to the blockchain node protocol. Another condition for a transaction to be valid is that the output of the preceding transaction 152i which it attempts to redeem has not already been redeemed by another transaction. Again if not valid, the transaction 152j will not be propagated (unless flagged as invalid and propagated for alerting) or recorded in the blockchain 150. This guards against double-spending whereby the transactor tries to assign the output of the same transaction more than once. An account-based model on the other hand guards against double-spending by maintaining an account balance. Because again there is a defined order of transactions, the account balance has a single defined state at any one time.

In addition to validating transactions, blockchain nodes 104 also race to be the first to create blocks of transactions in a process commonly referred to as mining, which is supported by “proof-of-work”. At a blockchain node 104, new transactions are added to an ordered pool 154 of valid transactions that have not yet appeared in a block 151 recorded on the blockchain 150. The blockchain nodes then race to assemble a new valid block 151 of transactions 152 from the ordered set of transactions 154 by attempting to solve a cryptographic puzzle. Typically this comprises searching for a “nonce” value such that when the nonce is concatenated with a representation of the ordered pool of pending transactions 154 and hashed, then the output of the hash meets a predetermined condition. E.g. the predetermined condition may be that the output of the hash has a certain predefined number of leading zeros. Note that this is just one particular type of proof-of-work puzzle, and other types are not excluded. A property of a hash function is that it has an unpredictable output with respect to its input. Therefore this search can only be performed by brute force, thus consuming a substantive amount of processing resource at each blockchain node 104 that is trying to solve the puzzle.

The first blockchain node 104 to solve the puzzle announces this to the network 106, providing the solution as proof which can then be easily checked by the other blockchain nodes 104 in the network (once given the solution to a hash it is straightforward to check that it causes the output of the hash to meet the condition). The first blockchain node 104 propagates a block to a threshold consensus of other nodes that accept the block and thus enforce the protocol rules. The ordered set of transactions 154 then becomes recorded as a new block 151 in the blockchain 150 by each of the blockchain nodes 104. A block pointer 155 is also assigned to the new block 151n pointing back to the previously created block 151n-1 in the chain. The significant amount of effort, for example in the form of hash, required to create a proof-of-work solution signals the intent of the first node 104 to follow the rules of the blockchain protocol. Such rules include not accepting a transaction as valid if it spends or assigns the same output as a previously validated transaction, otherwise known as double-spending. Once created, the block 151 cannot be modified since it is recognized and maintained at each of the blockchain nodes 104 in the blockchain network 106. The block pointer 155 also imposes a sequential order to the blocks 151. Since the transactions 152 are recorded in the ordered blocks at each blockchain node 104 in a network 106, this therefore provides an immutable public ledger of the transactions.

Note that different blockchain nodes 104 racing to solve the puzzle at any given time may be doing so based on different snapshots of the pool of yet-to-be published transactions 154 at any given time, depending on when they started searching for a solution or the order in which the transactions were received. Whoever solves their respective puzzle first defines which transactions 152 are included in the next new block 151n and in which order, and the current pool 154 of unpublished transactions is updated. The blockchain nodes 104 then continue to race to create a block from the newly-defined ordered pool of unpublished transactions 154, and so forth. A protocol also exists for resolving any “fork” that may arise, which is where two blockchain nodes 104 solve their puzzle within a very short time of one another such that a conflicting view of the blockchain gets propagated between nodes 104. In short, whichever prong of the fork grows the longest becomes the definitive blockchain 150. Note this should not affect the users or agents of the network as the same transactions will appear in both forks.

According to the bitcoin blockchain (and most other blockchains) a node that successfully constructs a new block 104 is granted the ability to newly assign an additional, accepted amount of the digital asset in a new special kind of transaction which distributes an additional defined quantity of the digital asset (as opposed to an inter-agent, or inter-user transaction which transfers an amount of the digital asset from one agent or user to another). This special type of transaction is usually referred to as a “coinbase transaction”, but may also be termed an “initiation transaction” or “generation transaction”. It typically forms the first transaction of the new block 151n. The proof-of-work signals the intent of the node that constructs the new block to follow the protocol rules allowing this special transaction to be redeemed later. The blockchain protocol rules may require a maturity period, for example 100 blocks, before this special transaction may be redeemed. Often a regular (non-generation) transaction 152 will also specify an additional transaction fee in one of its outputs, to further reward the blockchain node 104 that created the block 151n in which that transaction was published. This fee is normally referred to as the “transaction fee”, and is discussed blow.

Due to the resources involved in transaction validation and publication, typically at least each of the blockchain nodes 104 takes the form of a server comprising one or more physical server units, or even whole a data centre. However in principle any given blockchain node 104 could take the form of a user terminal or a group of user terminals networked together.

The memory of each blockchain node 104 stores software configured to run on the processing apparatus of the blockchain node 104 in order to perform its respective role or roles and handle transactions 152 in accordance with the blockchain node protocol. It will be understood that any action attributed herein to a blockchain node 104 may be performed by the software run on the processing apparatus of the respective computer equipment. The node software may be implemented in one or more applications at the application layer, or a lower layer such as the operating system layer or a protocol layer, or any combination of these.

Also connected to the network 101 is the computer equipment 102 of each of a plurality of parties 103 in the role of consuming users. These users may interact with the blockchain network 106 but do not participate in validating transactions or constructing blocks. Some of these users or agents 103 may act as senders and recipients in transactions. Other users may interact with the blockchain 150 without necessarily acting as senders or recipients. For instance, some parties may act as storage entities that store a copy of the blockchain 150 (e.g. having obtained a copy of the blockchain from a blockchain node 104).

Some or all of the parties 103 may be connected as part of a different network, e.g. a network overlaid on top of the blockchain network 106. Users of the blockchain network (often referred to as “clients”) may be said to be part of a system that includes the blockchain network 106; however, these users are not blockchain nodes 104 as they do not perform the roles required of the blockchain nodes. Instead, each party 103 may interact with the blockchain network 106 and thereby utilize the blockchain 150 by connecting to (i.e. communicating with) a blockchain node 106. Two parties 103 and their respective equipment 102 are shown for illustrative purposes: a first party 103a and his/her respective computer equipment 102a, and a second party 103b and his/her respective computer equipment 102b. It will be understood that many more such parties 103 and their respective computer equipment 102 may be present and participating in the system 100, but for convenience they are not illustrated. Each party 103 may be an individual or an organization. Purely by way of illustration the first party 103a is referred to herein as Alice and the second party 103b is referred to as Bob, but it will be appreciated that this is not limiting and any reference herein to Alice or Bob may be replaced with “first party” and “second “party” respectively.

The computer equipment 102 of each party 103 comprises respective processing apparatus comprising one or more processors, e.g. one or more CPUs, GPUs, other accelerator processors, application specific processors, and/or FPGAs. The computer equipment 102 of each party 103 further comprises memory, i.e. computer-readable storage in the form of a non-transitory computer-readable medium or media. This memory may comprise one or more memory units employing one or more memory media, e.g. a magnetic medium such as hard disk; an electronic medium such as an SSD, flash memory or EEPROM; and/or an optical medium such as an optical disc drive. The memory on the computer equipment 102 of each party 103 stores software comprising a respective instance of at least one client application 105 arranged to run on the processing apparatus. It will be understood that any action attributed herein to a given party 103 may be performed using the software run on the processing apparatus of the respective computer equipment 102. The computer equipment 102 of each party 103 comprises at least one user terminal, e.g. a desktop or laptop computer, a tablet, a smartphone, or a wearable device such as a smartwatch. The computer equipment 102 of a given party 103 may also comprise one or more other networked resources, such as cloud computing resources accessed via the user terminal.

The client application 105 may be initially provided to the computer equipment 102 of any given party 103 on suitable computer-readable storage medium or media, e.g. downloaded from a server, or provided on a removable storage device such as a removable SSD, flash memory key, removable EEPROM, removable magnetic disk drive, magnetic floppy disk or tape, optical disk such as a CD or DVD ROM, or a removable optical drive, etc.

The client application 105 comprises at least a “wallet” function. This has two main functionalities. One of these is to enable the respective party 103 to create, authorise (for example sign) and send transactions 152 to one or more bitcoin nodes 104 to then be propagated throughout the network of blockchain nodes 104 and thereby included in the blockchain 150. The other is to report back to the respective party the amount of the digital asset that he or she currently owns. In an output-based system, this second functionality comprises collating the amounts defined in the outputs of the various 152 transactions scattered throughout the blockchain 150 that belong to the party in question.

Note: whilst the various client functionality may be described as being integrated into a given client application 105, this is not necessarily limiting and instead any client functionality described herein may instead be implemented in a suite of two or more distinct applications, e.g. interfacing via an API, or one being a plug-in to the other. More generally the client functionality could be implemented at the application layer or a lower layer such as the operating system, or any combination of these. The following will be described in terms of a client application 105 but it will be appreciated that this is not limiting.

The instance of the client application or software 105 on each computer equipment 102 is operatively coupled to at least one of the blockchain nodes 104 of the network 106. This enables the wallet function of the client 105 to send transactions 152 to the network 106. The client 105 is also able to contact blockchain nodes 104 in order to query the blockchain 150 for any transactions of which the respective party 103 is the recipient (or indeed inspect other parties' transactions in the blockchain 150, since in embodiments the blockchain 150 is a public facility which provides trust in transactions in part through its public visibility). The wallet function on each computer equipment 102 is configured to formulate and send transactions 152 according to a transaction protocol. As set out above, each blockchain node 104 runs software configured to validate transactions 152 according to the blockchain node protocol, and to forward transactions 152 in order to propagate them throughout the blockchain network 106. The transaction protocol and the node protocol correspond to one another, and a given transaction protocol goes with a given node protocol, together implementing a given transaction model. The same transaction protocol is used for all transactions 152 in the blockchain 150. The same node protocol is used by all the nodes 104 in the network 106.

When a given party 103, say Alice, wishes to send a new transaction 152j to be included in the blockchain 150, then she formulates the new transaction in accordance with the relevant transaction protocol (using the wallet function in her client application 105). She then sends the transaction 152 from the client application 105 to one or more blockchain nodes 104 to which she is connected. E.g. this could be the blockchain node 104 that is best connected to Alice's computer 102. When any given blockchain node 104 receives a new transaction 152j, it handles it in accordance with the blockchain node protocol and its respective role. This comprises first checking whether the newly received transaction 152j meets a certain condition for being “valid”, examples of which will be discussed in more detail shortly. In some transaction protocols, the condition for validation may be configurable on a per-transaction basis by scripts included in the transactions 152. Alternatively the condition could simply be a built-in feature of the node protocol, or be defined by a combination of the script and the node protocol.

On condition that the newly received transaction 152j passes the test for being deemed valid (i.e. on condition that it is “validated”), any blockchain node 104 that receives the transaction 152j will add the new validated transaction 152 to the ordered set of transactions 154 maintained at that blockchain node 104. Further, any blockchain node 104 that receives the transaction 152j will propagate the validated transaction 152 onward to one or more other blockchain nodes 104 in the network 106. Since each blockchain node 104 applies the same protocol, then assuming the transaction 152j is valid, this means it will soon be propagated throughout the whole network 106.

Once admitted to the ordered pool of pending transactions 154 maintained at a given blockchain node 104, that blockchain node 104 will start competing to solve the proof-of-work puzzle on the latest version of their respective pool of 154 including the new transaction 152 (recall that other blockchain nodes 104 may be trying to solve the puzzle based on a different pool of transactions 154, but whoever gets there first will define the set of transactions that are included in the latest block 151. Eventually a blockchain node 104 will solve the puzzle for a part of the ordered pool 154 which includes Alice's transaction 152j). Once the proof-of-work has been done for the pool 154 including the new transaction 152j, it immutably becomes part of one of the blocks 151 in the blockchain 150. Each transaction 152 comprises a pointer back to an earlier transaction, so the order of the transactions is also immutably recorded.

Different blockchain nodes 104 may receive different instances of a given transaction first and therefore have conflicting views of which instance is ‘valid’ before one instance is published in a new block 151, at which point all blockchain nodes 104 agree that the published instance is the only valid instance. If a blockchain node 104 accepts one instance as valid, and then discovers that a second instance has been recorded in the blockchain 150 then that blockchain node 104 must accept this and will discard (i.e. treat as invalid) the instance which it had initially accepted (i.e. the one that has not been published in a block 151).

An alternative type of transaction protocol operated by some blockchain networks may be referred to as an “account-based” protocol, as part of an account-based transaction model. In the account-based case, each transaction does not define the amount to be transferred by referring back to the UTXO of a preceding transaction in a sequence of past transactions, but rather by reference to an absolute account balance. The current state of all accounts is stored, by the nodes of that network, separate to the blockchain and is updated constantly. In such a system, transactions are ordered using a running transaction tally of the account (also called the “position”). This value is signed by the sender as part of their cryptographic signature and is hashed as part of the transaction reference calculation. In addition, an optional data field may also be signed the transaction. This data field may point back to a previous transaction, for example if the previous transaction ID is included in the data field.

### 2. UTXO-Based Model

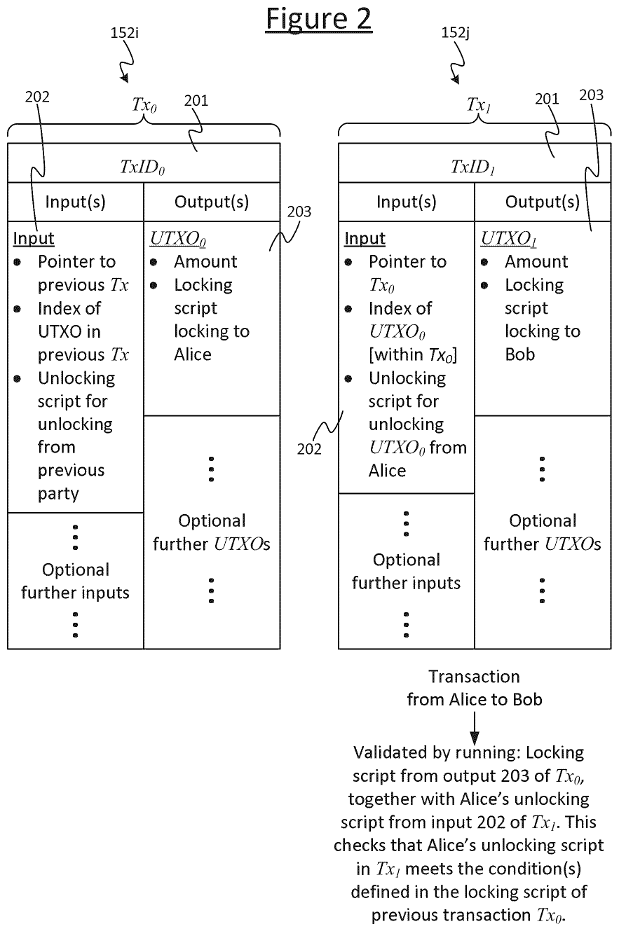

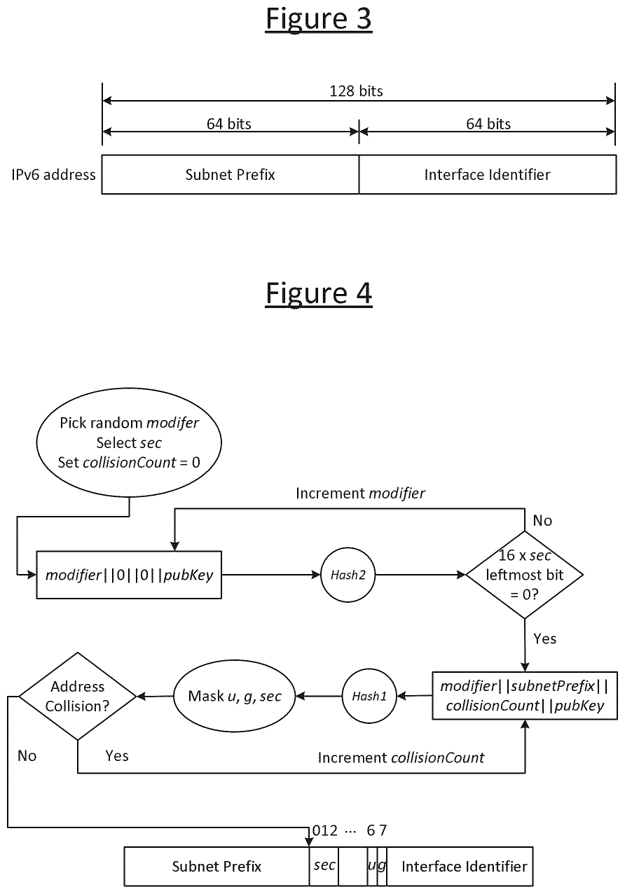

FIG. 2 illustrates an example transaction protocol. This is an example of a UTXO-based protocol. A transaction 152 (abbreviated “Tx”) is the fundamental data structure of the blockchain 150 (each block 151 comprising one or more transactions 152). The following will be described by reference to an output-based or “UTXO” based protocol. However, this is not limiting to all possible embodiments. Note that while the example UTXO-based protocol is described with reference to bitcoin, it may equally be implemented on other example blockchain networks.

In a UTXO-based model, each transaction (“Tx”) 152 comprises a data structure comprising one or more inputs 202, and one or more outputs 203. Each output 203 may comprise an unspent transaction output (UTXO), which can be used as the source for the input 202 of another new transaction (if the UTXO has not already been redeemed). The UTXO includes a value specifying an amount of a digital asset. This represents a set number of tokens on the distributed ledger. The UTXO may also contain the transaction ID of the transaction from which it came, amongst other information. The transaction data structure may also comprise a header 201, which may comprise an indicator of the size of the input field(s) 202 and output field(s) 203. The header 201 may also include an ID of the transaction. In embodiments the transaction ID is the hash of the transaction data (excluding the transaction ID itself) and stored in the header 201 of the raw transaction 152 submitted to the nodes 104.

Say Alice 103a wishes to create a transaction 152j transferring an amount of the digital asset in question to Bob 103b. In FIG. 2 Alice's new transaction 152j is labelled “Tx₁”. It takes an amount of the digital asset that is locked to Alice in the output 203 of a preceding transaction 152i in the sequence, and transfers at least some of this to Bob. The preceding transaction 152i is labelled “Tx₀” in FIG. 2. Tx₀ and Tx₁ are just arbitrary labels. They do not necessarily mean that Tx₀ is the first transaction in the blockchain 151, nor that Tx₁ is the immediate next transaction in the pool 154. Tx₁ could point back to any preceding (i.e. antecedent) transaction that still has an unspent output 203 locked to Alice.

The preceding transaction Tx₀ may already have been validated and included in a block 151 of the blockchain 150 at the time when Alice creates her new transaction Tx₁, or at least by the time she sends it to the network 106. It may already have been included in one of the blocks 151 at that time, or it may be still waiting in the ordered set 154 in which case it will soon be included in a new block 151. Alternatively Tx₀ and Tx₁ could be created and sent to the network 106 together, or Tx₀ could even be sent after Tx₁ if the node protocol allows for buffering “orphan” transactions. The terms “preceding” and “subsequent” as used herein in the context of the sequence of transactions refer to the order of the transactions in the sequence as defined by the transaction pointers specified in the transactions (which transaction points back to which other transaction, and so forth). They could equally be replaced with “predecessor” and “successor”, or “antecedent” and “descendant”, “parent” and “child”, or such like. It does not necessarily imply an order in which they are created, sent to the network 106, or arrive at any given blockchain node 104. Nevertheless, a subsequent transaction (the descendent transaction or “child”) which points to a preceding transaction (the antecedent transaction or “parent”) will not be validated until and unless the parent transaction is validated. A child that arrives at a blockchain node 104 before its parent is considered an orphan. It may be discarded or buffered for a certain time to wait for the parent, depending on the node protocol and/or node behaviour.

One of the one or more outputs 203 of the preceding transaction Tx₀ comprises a particular UTXO, labelled here UTXO₀. Each UTXO comprises a value specifying an amount of the digital asset represented by the UTXO, and a locking script which defines a condition which must be met by an unlocking script in the input 202 of a subsequent transaction in order for the subsequent transaction to be validated, and therefore for the UTXO to be successfully redeemed. Typically the locking script locks the amount to a particular party (the beneficiary of the transaction in which it is included). I.e. the locking script defines an unlocking condition, typically comprising a condition that the unlocking script in the input of the subsequent transaction comprises the cryptographic signature of the party to whom the preceding transaction is locked.

The locking script (aka scriptPubKey) is a piece of code written in the domain specific language recognized by the node protocol. A particular example of such a language is called “Script” (capital S) which is used by the blockchain network. The locking script specifies what information is required to spend a transaction output 203, for example the requirement of Alice's signature. Unlocking scripts appear in the outputs of transactions. The unlocking script (aka scriptSig) is a piece of code written the domain specific language that provides the information required to satisfy the locking script criteria. For example, it may contain Bob's signature. Unlocking scripts appear in the input 202 of transactions.

So in the example illustrated, UTXO₀ in the output 203 of Tx₀ comprises a locking script [Checksig P_{A}] which requires a signature Sig P_{A} of Alice in order for UTXO₀ to be redeemed (strictly, in order for a subsequent transaction attempting to redeem UTXO₀ to be valid). [Checksig P_{A}] contains a representation (i.e. a hash) of the public key P_{A} from a public-private key pair of Alice. The input 202 of Tx₁ comprises a pointer pointing back to Tx₁ (e.g. by means of its transaction ID, TxID₀, which in embodiments is the hash of the whole transaction Tx₀). The input 202 of Tx₁ comprises an index identifying UTXO₀ within Tx₀, to identify it amongst any other possible outputs of Tx₀. The input 202 of Tx₁ further comprises an unlocking script <Sig P_{A}> which comprises a cryptographic signature of Alice, created by Alice applying her private key from the key pair to a predefined portion of data (sometimes called the “message” in cryptography). The data (or “message”) that needs to be signed by Alice to provide a valid signature may be defined by the locking script, or by the node protocol, or by a combination of these.

When the new transaction Tx₁ arrives at a blockchain node 104, the node applies the node protocol. This comprises running the locking script and unlocking script together to check whether the unlocking script meets the condition defined in the locking script (where this condition may comprise one or more criteria). In embodiments this involves concatenating the two scripts:

$$〈 Sig {P}_{A} 〉 〈 {P}_{A} 〉 \vert \vert [ Checksig {P}_{A} ]$$

where “∥” represents a concatenation and “< . . . >” means place the data on the stack, and “[ . . . ]” is a function comprised by the locking script (in this example a stack-based language).

Equivalently the scripts may be run one after the other, with a common stack, rather than concatenating the scripts. Either way, when run together, the scripts use the public key P_{A} of Alice, as included in the locking script in the output of Tx₀, to authenticate that the unlocking script in the input of Tx₁ contains the signature of Alice signing the expected portion of data. The expected portion of data itself (the “message”) also needs to be included in order to perform this authentication. In embodiments the signed data comprises the whole of Tx₁ (so a separate element does not need to be included specifying the signed portion of data in the clear, as it is already inherently present).

The details of authentication by public-private cryptography will be familiar to a person skilled in the art. Basically, if Alice has signed a message using her private key, then given Alice's public key and the message in the clear, another entity such as a node 104 is able to authenticate that the message must have been signed by Alice. Signing typically comprises hashing the message, signing the hash, and tagging this onto the message as a signature, thus enabling any holder of the public key to authenticate the signature. Note therefore that any reference herein to signing a particular piece of data or part of a transaction, or such like, can in embodiments mean signing a hash of that piece of data or part of the transaction.

If the unlocking script in Tx₁ meets the one or more conditions specified in the locking script of Tx₀ (so in the example shown, if Alice's signature is provided in Tx₁ and authenticated), then the blockchain node 104 deems Tx₁ valid. This means that the blockchain node 104 will add Tx₁ to the ordered pool of pending transactions 154. The blockchain node 104 will also forward the transaction Tx₁ to one or more other blockchain nodes 104 in the network 106, so that it will be propagated throughout the network 106. Once Tx₁ has been validated and included in the blockchain 150, this defines UTXO₀ from Tx₀ as spent. Note that Tx₁ can only be valid if it spends an unspent transaction output 203. If it attempts to spend an output that has already been spent by another transaction 152, then Tx₁ will be invalid even if all the other conditions are met. Hence the blockchain node 104 also needs to check whether the referenced UTXO in the preceding transaction Tx₀ is already spent (i.e. whether it has already formed a valid input to another valid transaction). This is one reason why it is important for the blockchain 150 to impose a defined order on the transactions 152. In practice a given blockchain node 104 may maintain a separate database marking which UTXOs 203 in which transactions 152 have been spent, but ultimately what defines whether a UTXO has been spent is whether it has already formed a valid input to another valid transaction in the blockchain 150.

If the total amount specified in all the outputs 203 of a given transaction 152 is greater than the total amount pointed to by all its inputs 202, this is another basis for invalidity in most transaction models. Therefore such transactions will not be propagated nor included in a block 151.

Note that in UTXO-based transaction models, a given UTXO needs to be spent as a whole. It cannot “leave behind” a fraction of the amount defined in the UTXO as spent while another fraction is spent. However the amount from the UTXO can be split between multiple outputs of the next transaction. E.g. the amount defined in UTXO₀ in Tx₀ can be split between multiple UTXOs in Tx₁. Hence if Alice does not want to give Bob all of the amount defined in UTXO₀, she can use the remainder to give herself change in a second output of Tx₁, or pay another party.

In practice Alice will also usually need to include a fee for the bitcoin node 104 that successfully includes her transaction 104 in a block 151. If Alice does not include such a fee, Tx₀ may be rejected by the blockchain nodes 104, and hence although technically valid, may not be propagated and included in the blockchain 150 (the node protocol does not force blockchain nodes 104 to accept transactions 152 if they don't want). In some protocols, the transaction fee does not require its own separate output 203 (i.e. does not need a separate UTXO). Instead any difference between the total amount pointed to by the input(s) 202 and the total amount of specified in the output(s) 203 of a given transaction 152 is automatically given to the blockchain node 104 publishing the transaction. E.g. say a pointer to UTXO₀ is the only input to Tx₁, and Tx₁ has only one output UTXO₁. If the amount of the digital asset specified in UTXO₀ is greater than the amount specified in UTXO₁, then the difference may be assigned (or spent) by the node 104 that wins the proof-of-work race to create the block containing UTXO₁. Alternatively or additionally however, it is not necessarily excluded that a transaction fee could be specified explicitly in its own one of the UTXOs 203 of the transaction 152.

Alice and Bob's digital assets consist of the UTXOs locked to them in any transactions 152 anywhere in the blockchain 150. Hence typically, the assets of a given party 103 are scattered throughout the UTXOs of various transactions 152 throughout the blockchain 150. There is no one number stored anywhere in the blockchain 150 that defines the total balance of a given party 103. It is the role of the wallet function in the client application 105 to collate together the values of all the various UTXOs which are locked to the respective party and have not yet been spent in another onward transaction. It can do this by querying the copy of the blockchain 150 as stored at any of the bitcoin nodes 104.

Note that the script code is often represented schematically (i.e. not using the exact language). For example, one may use operation codes (opcodes) to represent a particular function. “OP_. . . ” refers to a particular opcode of the Script language. As an example, OP_RETURN is an opcode of the Script language that when preceded by OP_FALSE at the beginning of a locking script creates an unspendable output of a transaction that can store data within the transaction, and thereby record the data immutably in the blockchain 150. E.g. the data could comprise a document which it is desired to store in the blockchain.

Typically an input of a transaction contains a digital signature corresponding to a public key P_{A}. In embodiments this is based on the ECDSA using the elliptic curve secp256k1. A digital signature signs a particular piece of data. In some embodiments, for a given transaction the signature will sign part of the transaction input, and some or all of the transaction outputs. The particular parts of the outputs it signs depends on the SIGHASH flag. The SIGHASH flag is usually a 4-byte code included at the end of a signature to select which outputs are signed (and thus fixed at the time of signing).

The locking script is sometimes called “scriptPubKey” referring to the fact that it typically comprises the public key of the party to whom the respective transaction is locked. The unlocking script is sometimes called “scriptSig” referring to the fact that it typically supplies the corresponding signature. However, more generally it is not essential in all applications of a blockchain 150 that the condition for a UTXO to be redeemed comprises authenticating a signature. More generally the scripting language could be used to define any one or more conditions. Hence the more general terms “locking script” and “unlocking script” may be preferred.

### 3. Side Channel

As shown in FIG. 1, the client application on each of Alice and Bob's computer equipment 102a, 120b, respectively, may comprise additional communication functionality. This additional functionality enables Alice 103a to establish a separate side channel 107 with Bob 103b (at the instigation of either party or a third party). The side channel 107 enables exchange of data separately from the blockchain network. Such communication is sometimes referred to as “off-chain” communication. For instance this may be used to exchange a transaction 152 between Alice and Bob without the transaction (yet) being registered onto the blockchain network 106 or making its way onto the chain 150, until one of the parties chooses to broadcast it to the network 106. Sharing a transaction in this way is sometimes referred to as sharing a “transaction template”. A transaction template may lack one or more inputs and/or outputs that are required in order to form a complete transaction. Alternatively or additionally, the side channel 107 may be used to exchange any other transaction related data, such as keys, negotiated amounts or terms, data content, etc.

The side channel 107 may be established via the same packet-switched network 101 as the blockchain network 106. Alternatively or additionally, the side channel 301 may be established via a different network such as a mobile cellular network, or a local area network such as a local wireless network, or even a direct wired or wireless link between Alice and Bob's devices 102a, 102b. Generally, the side channel 107 as referred to anywhere herein may comprise any one or more links via one or more networking technologies or communication media for exchanging data “off-chain”, i.e. separately from the blockchain network 106. Where more than one link is used, then the bundle or collection of off-chain links as a whole may be referred to as the side channel 107. Note therefore that if it is said that Alice and Bob exchange certain pieces of information or data, or such like, over the side channel 107, then this does not necessarily imply all these pieces of data have to be send over exactly the same link or even the same type of network.

### 4. Cryptographically Generated Addresses (CGA)

IPv6 addresses are 128-bit addresses where the leftmost 64 bits form the subnet prefix and the rightmost 64 bits form the interface identifier. The subnet prefix is used to determine the nodes' location in the Internet topology and the interface identifier is used as an identity of the node.

Cryptographically Generated Addresses (CGA) are IPv6 addresses for which the interface identifier is generated by applying a cryptographic hash function on a public key and additional auxiliary parameters. The binding between the public key and the address can be verified by re-computing the hash value and comparing it with the interface identifier of the address. CGA allows nodes to generate their own addresses and verify others' without relying on any security infrastructure.

CGA is used in the SEND protocol to prevent spoofing and DoS attacks. A spoofing attack occurs when an attacker in a local network manages to spoof router advertisement messages so that packets destined to some legitimate node are redirected to some other link-layer address. In a DoS attack, the attacker disrupts the Duplicate Address Detection (DAD) protocol by responding to every DAD attempt made by an entering node. In this way the new legitimate node is unable to obtain an address. CGA was designed to mitigate these attacks by giving a way to nodes to prove they control the address they advertise.

With the advancement of technology, it was quickly realised that the 64 bits of the interface identifier would not be enough to protect CGA against brute-force attacks. A brute-force attack occurs when an attacker manages to find another valid public/private key from a given address. In order to mitigate this attack, CGA added a hash extension technique to the generation of new addresses. This technique requires nodes to solve a PoW-like puzzle whose difficulty depends on a parametrizable security parameter. This technique increases the cost of both address generation and brute-forcing attack by the same factor but keeps the cost of address use and verification constant. The security parameter can be selected depending on the computational capacity of the address generator, the perceived risk of attacks, and the expected lifetime of the address.

### 4.1 Specification

### 4.1.1 CGA Format

Each CGA is associated with a set of auxiliary parameters, called the CGA Parameters data structure, which consists of the following values:
modifier: a random 128-bit unsigned integer. This modifier is used during CGA generation to implement the hash extension technique and to enhance privacy by adding randomness to the address.
subnetPrefix: the 64-bit subnet prefix to which the CGA belongs.
collisionCount: an 8-bit unsigned integer that must be 0, 1, or 2. The collision count is incremented during CGA generation to recover from an address collision detected by DAD.
pubKey: the public key as a DER-encoded ASN.1 structure of the type SubjectPublicKeyInfo defined in the Internet X.509 certificate profile.
extensionFields: an optional variable-length fields that can be used for additional data items. By default, it has length 0.

A CGA also has a 3-bit security parameter sec encoded in the three leftmost bits of the interface identifier. This parameter determines the strength of the CGA against brute-force attacks.

### 4.1.2 CGA Generation

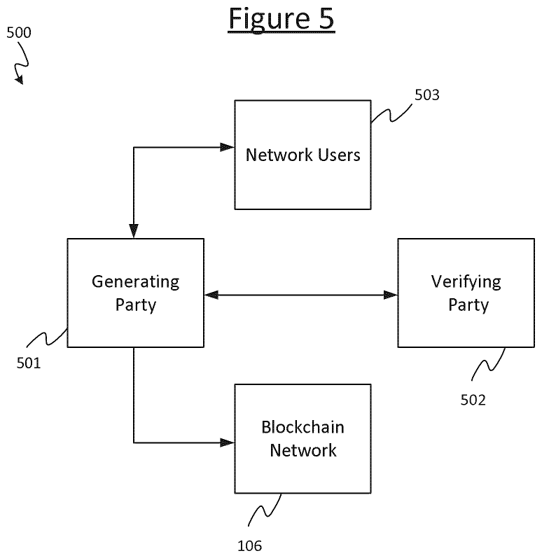

The CGA generation algorithm takes as input four values: the subnet prefix, the public key of the address owner, the security parameter sec, and any optional extension fields. The algorithm is illustrated in FIG. 4 and works as follows:
1. Set modifier to a random 128-bit value.
2. Compute Hash2 by hashing the concatenation of modifier, 9 zero bytes, pubKey, and extensionFields (if there is any), and taking the 112 leftmost bits of the resulting hash value.
3. Check if the 16×sec leftmost bits of Hash2 are zero. If it is the case, continue with step 4. Otherwise, increment modifier by one and go back to step 2.
4. Set the 8-bit collisionCount to zero.
5. Compute Hash1 by hashing the concatenation of modifier, subnetPrefix, collisionCount, pubKey, and extensionFields (if there is any), and taking the 64 leftmost bits of the resulting hash value.
6. Construct the interface identifier from Hash1 by encoding the value of sec into the three leftmost bits and by setting the u and g bits (bits 6 and 7 when starting with 0 from the left) to zero. When using CGA, the u and g bits are ignored. Setting them to 0 is just an arbitrary convention.
7. Concatenate the 64-bit subnet prefix and the 64-bit interface identifier to form a 128-bit IPv6 address.
8. Perform DAD if required. If an address collision is detected, increment collisionCount by one and go back to step 5. After three collisions, stop and report the error.

The CGA Parameters data structure is formed by concatenating the final modifier value, the subnet prefix, the final collision count value, the encoded public key, and any optional extension fields. The cost of generating a new CGA depends exponentially on the parameter see, which can have value from 0 (lowest security) to 7 (highest security).

### 4.1.3 CGA Verification

The CGA verification algorithm takes as input the CGA and the CGA Parameters data structure. The CGA verification algorithm works as follows:
1. Check that collisionCount is equal to 0, 1, or 2.
2. Check that subnetPrefix is equal to the subnet prefix of the CGA.
3. Compute Hash1 and check that it is equal to the interface identifier of the CGA. Differences in the three leftmost bits and in the u and g bits are ignored.
4. Compute Hash2 and check that the 16×sec leftmost bits of the resulting hash values are zero.

If the verification succeeds, then the binding between the public key in the CGA Parameters data structure and the address is verified. The verification algorithm is relatively fast and always requires at most two hash computations. If sec=0, step 4. can be skipped and the verification only requires one hash computation.

### 4.1.4 Design Rationale

The collisionCount value is used to modify the input to Hash1 if there is an address collision. It is important to verify that collisionCount is in the range 0 to 2. First, it is very unlikely that three collisions would occur, and the reason would certainly be either a configuration or implementation error or a denial-of-service attack. But more importantly, an attacker doing a brute-force search to match a given CGA can try all different values of collisionCount without having to find a new modifier. Thus, if higher values were allowed for collisionCount, the hash extension technique would be less effective in preventing brute-force attacks.

Including the subnet prefix as input of Hash1 implies that in different subnets, distinct interface identifiers will be generated from the same public key. Therefore, an attacker cannot brute force all CGAs with the same interface identifier and different subnet prefixes at once.

The benefit of not including the subnet prefix as input of Hash2 is to allow mobile nodes moving from one subnet to another to reuse old modifier values to generate new addresses. However, reusing modifier values may make it easier for an observer to link two addresses to each other. As described in Section 4.2, this also enables an attacker to construct a time-memory trade-off attack to spoof the address of a random node in a network for any subnet prefix.

### 4.1.5 Spoofing Attack

The goal of CGA is to prevent spoofing of existing IPv6 addresses by binding the IPv6 address to the public key of the address owner. In CGA, a spoofing attack occurs when an attacker successfully finds a set of valid CGA parameters that binds the attacker's public key with a specific address. This gives the ability to the attacker to misrepresent itself as another node by presenting a public key that binds correctly to the target address.

The property of the hash function used in Hash1 and Hash2 to prevent spoofing attacks is called second pre-image resistance. Second pre-image resistance for a hash function H implies that, given a message M, it is hard to find another message M′ such that H(M)=H(M′). If the hash function has this property, then the only way for an attacker to spoof a CGA is to brute force it.

The cost of spoofing an address by brute forcing the CGA can be calculated as follows. Of the 64 bits of Hash1, 5 bits are ignored during the CGA verification, corresponding to the sec bits and the u and g bits. If sec=0, then finding a set of CGA parameters that yields the desired CGA requires O(2⁵⁹) hash function evaluations. The hash extension technique requires the leftmost 16×sec bits of the Hash2 value to be zero, which increases the cost of address generation approximately by a factor of 2^{16×sec}. It also increases the cost of brute-force attacks by the same factor. That is, spoofing an address by brute forcing it requires O(2^{59+16×sec}) hash function evaluations.

### 4.2 Limitations

This section discusses the drawbacks and limitations of CGA.

### 4.2.1 Trading Off Efficiency for Security

The choice of the security parameter sec affects both the cost for nodes to generate new addresses and for an attacker to brute-force an address. Therefore, CGA introduces a trade-off between security and performance. Selecting a large sec value may cause unreasonable delay in address generation while a low sec value decreases the security of the algorithm. Hash values longer than or equal to 128 bits are considered secure for any reasonable future while a minimum of 80 bits is necessary for the immediate future. This suggests using a minimum of sec=2 during CGA generation, which yields a security of 91 bits. It has been shown that generating new addresses with sec=2 takes several minutes on a modern CPU processor. For low-end devices, it has been found that only zero value of sec is practical.

Given these results, it can be concluded that standard machines are not able to generate secure CGAs on the fly.

For these reasons, it is recommended to delegate the expensive part of the address generation to a more powerful computer. This work can be done in advance or offline, rather than in real time when a new address is needed. However, this outlook turns back the approach to a centralised model which fails if the external computer is compromised.

### 4.2.2 Time-Memory Trade-Off Attack

In order for mobile nodes to efficiently generate new addresses when their location changes, the subnet prefix is not included as input of Hash2. This weakness can be exploited to build a time-memory trade-off attack to spoof the address of a random node in a network for any subnet prefix.

To mount this attack, the attacker starts by generating a valid public/private key pair; this needs to be done only once. For a network of size 2ⁿ, the attacker creates a database of 2⁵⁹⁻ⁿ modifier values such that the leftmost 16×sec bits of Hash2 are zero. Creating such a database requires O(2^{59+16×sec-n}) hash function evaluations. Using this database, the attacker then only needs O(2⁵⁹⁻ⁿ) calls to the hash function and comparisons of the hash values to find a modifier value that yields the address of a random node in the network. Since the subnet prefix is not included as input of Hash2, the database can be reused for any subnet prefix. In the long run, this attack eliminates the effect of the hash extension technique because once the database is created, the cost of an attack is independent of the sec parameter.

As an example, if an attacker wants to spoof the address of a random node in a network of size 2¹⁶ that uses sec=1, the database will require O(2⁵⁹) hash function evaluations to be built and take approximately 128 TB of space, which is significant but not impractical. The attacker then needs O(2⁴³) hash function evaluations and comparisons to find a suitable modifier value.

### 4.2.3 Replay Attack

The purpose of CGA is to bind cryptographically a public key to an IPv6 address. However, the verification process in CGA does not provide a mechanism to actually prove that the node controls the public key. This leads to a number of replay attacks, as described below. These replay attacks can be prevented by adding authentication outside of CGA, which implies adding an extra round of communication to set-up the channel.

An attacker could generate a CGA from a valid public key belonging to another node and create another valid address (for example by changing the modifier value or the subnet prefix). It cannot sign new messages but it could replay messages signed by the node and mislead other nodes by convincing them that he controls the address.

This type of replay attack can also target an address that already exists in the network. For a specific security parameter sec, the attacker can collect many valid modifier values and public keys, together with signed messages sent by these nodes. After having selected a subnet prefix, the attacker can search for a match in one of the existing addresses using the collected modifier values and public keys and start replaying messages.

Another instance of such a replay attack is to search for addresses with a non-zero collisionCount. The attacker can use the valid modifier value and public key of the node to generate an existing address in the network with collisionCount equal to zero.

### 4.2.4 Privacy Implications

In CGA, a node can generate multiple (pseudo-)random interface identifiers by executing the CGA generation algorithm multiple times with a different (pseudo-)random initial modifier value every time. The (pseudo-)random number generator used in the CGA generation algorithm should be strong enough to produce unpredictable and unlinkable values. However, the high cost of address generation in CGA may prevent nodes that use a high sec value from changing their address frequently. This is contrary to the recommendation of Narten et al., 2007, “Privacy Extensions for Stateless Address Autoconfiguration in IPv6”, RFC 4941, which advise nodes to change their interface identifier regularly. As pointed out, using the same identifier for a longer period of time makes it possible for an attacker to correlate the activity of a node, even as it moves topologically within the Internet. The correlation can be done by an attacker who is in the path between the node and the peers to which it is communicating, or by an attacker who can access the communication logs of the peers with which the node has communicated. The correlation can be based on payload contents of the packets on the wire or the packet characteristics such as packet size and timing.

### 5. Blockchain-Based Network Addresses

FIG. 5 shows an example system 500 for generating network addresses (e.g. IP addresses) based on blockchain-related information. The example system 500 includes a generating party 501 configured to generate a blockchain-based network address, a verifying party 502 configured to verify a blockchain-based network address, one or more blockchain nodes 104 of a blockchain network 106, and one or more users 503 of a network in which the network address is used to identify the generating party 501. Here, a user 503 of the network (a “network user”) may refer to a device 503 connected to the network.

For simplicity, the generating party 501 will be referred to as Alice 103a and the verifying party 502 will be referred to as Bob 103b. Both the generating party 501 and the verifying party 502 may be configured to perform some or all of the actions described above as being performed by either Alice 103a and/or Bob 103b. Note that this is merely for convenience, and in general the generating party 501 and verifying party 502 (or rather their respective computing device's) need only be configured to perform the actions described herein as being performed by the respective parties.

Alice 103a is associated with a public key (i.e. she controls the corresponding private key) and desires to generate a network address for a network to which she is connected. For example, Alice 103a may want to generate an IP address for receiving data over the internet 101. As a particular example, Alice 103a may want to generate an IPv6 address.

Alice 103a generates a first blockchain transaction that comprises a first data item based on her public key. In some examples, the first data item comprises the public key. In some examples, the first data item comprises a hash of the public key. The first blockchain transaction is sent to the blockchain network 106, either by Alice 103a or by an intermediary.

Information pertaining to the first blockchain transaction is used to generate a network address associated with Alice's public key. The information relating to the first blockchain transaction may include information related to the block 151 (a “first block”) in which the first blockchain transaction is recorded. Thus once the first blockchain transaction is recorded in the blockchain 150, Alice 103a generates the network address based on one or more second data items. Each second data item is related to first blockchain transaction and/or the first block. It will be appreciated that “first” is merely used here as a label for a particular transaction and block. Alice 103a may obtain (e.g. from a blockchain node 104) a Merkle proof for proving that the first blockchain transaction has been recorded in the blockchain 150. Alice 103a may wait a certain amount of time (measured in blocks) before generating the address. For instance, Alice 103a may wait until at least six additional blocks have been added to the blockchain 150 after the first block.

In some examples, one or more of the second data items are related to (e.g. define) a location of the first blockchain transaction in the blockchain 150. For instance, one of the second data items may be a block height (i.e. a number of the block in the blockchain) of the first block. As another example, one of the second data items may be a transaction index. The transaction index indicates a position of the first blockchain transaction within the first block. That is, the transaction index i the first transaction is the ith transaction in the first block. Together, the block height and transaction index uniquely identify the position of the first blockchain transaction in the blockchain 150.

In some examples, one or more of the second data items are generated by hashing transaction-related data. For example, one of the second data items may be a transaction identifier of the first blockchain transaction, generated by hashing the first blockchain transaction. As another example, one of the second data items may be a block header of the first block, generated by hashing the first block.

In some examples, the network address may be generated prior to Alice 103a submitting the first blockchain transaction to the blockchain network 106. This allows Alice 103a to quickly generate addresses. For example, Alice 103a may generate the first blockchain transaction and then generate the network address based on information related to the first blockchain transaction, such as its transaction identifier. Recall that the transaction identifier is generated by hashing the transaction.

In some examples, Alice 103a may generate a first network address prior to submitting the first blockchain transaction to the blockchain network 106, and then generate a second network address once the first blockchain transaction is recorded on the blockchain 150 using information related to a location of the first blockchain transaction on the blockchain 150, such as the block height of the block 151 containing the first blockchain transaction.

In some examples, the network address may be based on a modifier value. Alice 103a may generate a plurality of modifier values. Different modifier values may be used to generate different network addresses. For security purposes, Alice 103a may generate a maximum of 2¹⁰ modifier values, i.e. no more than 2¹⁰ modifier values. Alice 103a may generate a third data item that encodes the plurality of different values. For example, the third data item may be a Merkle root of a Merkle tree generated based on the modifier values. In general any technique for encoding the values may be used, such as a partial commitment. The third data item may be included in the first blockchain transaction.

The network address may comprise a network prefix, which may be included in the first blockchain transaction.

As a particular example, the network address may be an IPv6 address used to identify Alice 103a (or rather her device) on the internet 101.

In the case where the one or more second data items include the block height of the first block and the index of the first blockchain transaction in the first block, the IPv6 address may be generated by encoding the block height as a 23-bit unsigned integer and encoding the transaction index as a 39-bit unsigned integer. Then, an interface identifier is generated by concatenating the 23-bit unsigned integer and the 39-bit unsigned integer and inserting two additional bits (e.g. zero bits) at the 6th and 7th bit positions. Then, the IPv6 address is generated by concatenating the network prefix and the interface identifier. Note that the block height and transaction identifier may be encoded using different values for their size, so long as the sum of their sizes is 62.

In some examples, one of the second data items may include a collision count value.

In the case where the one or more second data items include a modifier value, a block header of the first block, a collision count value, and a transaction identifier of the first blockchain transaction, the IPv6 address may be generated by hashing a concatenation of the first modifier value, the blockheader, the collision count value, the transaction identifier, and the network prefix. Based on the resulting hash, an interface identifier is generated by extracting a leftmost 64 bits of the hash and inserting two additional bits (e.g. zero bits) at the 6th and 7th bit positions. Then, the IPv6 address is generated by concatenating the network prefix and the interface identifier.

In some examples, for improved security, the interface identifier may be based on a security parameter, sec. For example, the security parameter may form the first three bits of the interface identifier. When using an on-chain technique, the security parameter may be calculated based on a difficulty value encoded in the block header of the block containing the first blockchain transaction. The difficulty value, difficulty, is determined by the blockchain protocol. The security parameter may be calculated as sec=└ log₂(difficulty)/16┘+2.

As another example, when using an off-chain technique, the security parameter may be used to determine part of the block header upon which the interface identifier is based. As a particular example, the block header may be based on a Merkle root of the first blockchain transaction and one or more parameters. The values of the parameters may be iterated until a hash of the block header satisfies a requirement set by the security parameter. The requirement may be that a certain amount of leftmost bits of the hash are zero, e.g. 16×sec bits.

In some examples, the interface identifier may include a bit that indicates whether the first blockchain transaction has been recorded on the blockchain 150.

Alice 103a may share (e.g. advertise or transmit) her network address with one or more users of the network. Alice 103a may share her network address with Bob 103b for verification.

As an optional feature, Alice 103a may obtain a proof that the first blockchain transaction has been recorded on the blockchain 150. The proof may be a Merkle proof. The proof may be obtained from a blockchain node 104 or a different entity, or generated by Alice 103a. Alice 103a may send the proof to Bob 103b for verifying that the first blockchain transaction has been recorded on the blockchain 150, as part of verifying the network address.

As another optional feature, in examples where the network address is based on a modifier value, Alice 103a may obtain (e.g. generate) a proof that the third data item, included in the first blockchain transaction, contains the modifier value. In general any suitable proof may be used, such as a partial commitment. In the case where the third data item is a Merkle root of a Merkle tree generated based on the plurality of modifier values, the proof may be a Merkle proof. Alice 103a may send the proof to Bob 103b for verifying that the third data item encodes the modifier value, as part of verifying the network address.

To prove that Alice 103a owns the private key corresponding to the public key, Alice 103a may include a signature generated using the private key as part of the first blockchain transaction. Additionally or alternatively, Alice 103a may include an output in the first blockchain transaction that is locked to the public key, and submit a second blockchain transaction to the blockchain network 106 that includes an input which unlocks the output of the first blockchain transaction. The input of the second blockchain transaction includes a signature generated using the private key. In these examples, Alice 103a may obtain a proof that the second blockchain transaction has been recorded on the blockchain 150. The proof may be a Merkle proof. The proof may be obtained from a blockchain node 104 or a different entity, or generated by Alice 103a. Alice 103a may send the proof to Bob 103b for verifying that the second blockchain transaction has been recorded on the blockchain 150, as part of verifying the network address.

As mentioned, Bob 103b is configured to verify the network address is based on Alice's public key. To do so, Bob 103b obtains the network address and the public key. These may be obtained in any suitable way, e.g. received from Alice 103a. Bob 103b also obtains the first blockchain transaction. The first blockchain transaction may be obtained from the blockchain 150 or from Alice 103a, or from a different party. Bob 103b verifies that a first data item included in the first blockchain transaction is based on Alice's public key. For example, Bob 103b may hash the public key and verify that it matches the first data item.

Bob 103b obtains one or more second data items (e.g. the block height of the block containing the first blockchain transaction and the transaction index of the first transaction within that block) and constructs a candidate network address based on those second data items. Verification of the network address passes if the candidate network address is the same as the obtained network address.

Bob 103b may also use the proofs described above to verify the network address. For example, Bob 103b may obtain and use a proof that the first blockchain transaction has been recorded on the blockchain 150. Bob 103b may also obtain and use a proof that the third data item, included in the first blockchain transaction, contains the correct modifier value. See sections 6.2.1.3, 6.3.1.3 and 6.4 below for specific examples of how Bob 103b may use various proofs to verify the network address.

Bob 103b may verify that the block containing the first blockchain transaction contains no more than a predetermined maximum number of transactions, e.g. 2³² transactions. This may be verified using the proof (e.g. a Merkle proof) the first blockchain transaction has been recorded on the blockchain 150.

Bob 103b may verify that no more than a predetermined maximum number of modifier values (e.g. 2¹⁰) have been used to calculate network addresses.

In the case that the first blockchain transaction has not yet been recorded on the blockchain 150, Bob 103b may verify that the block containing the first blockchain transaction, on which the block header used to generate the network address is based, contains only the first blockchain transaction. Additionally or alternatively, Bob 103b may verify that the first blockchain transaction commits to only a single modifier value.

### 6. Blockchain-Certified IPv6 Addresses (BCA)

As discussed above, CGA provides a decentralised mechanism to securely bind public keys to IPv6 addresses. This binding is reinforced using a hash extension technique. As noted in Aura, March 2005, “Cryptographically Generated Addresses (CGA)”, RFC 3972, “the effectiveness of the hash extension depends on the assumption that the computational capacities of the attacker and the address generator will grow at the same (potentially exponential) rate”. However, this is not necessarily the case if addresses are generated on low-end mobile devices. Moreover, the development of highly parallel hardware in PoW-based blockchains has undermined this assumption even more. High sec values are needed to secure CGAs, which can render address generation unreasonably expensive on low-end devices.

Embodiments of the present disclosure can be used to leverage the apparent threat represented by the development of highly parallel hardware in PoW-based blockchains to create a more secure and efficient version of CGA, called Blockchain-Certified IPv6 Addresses (BCA). BCA entirely removes the trade-off between the security of the binding and the efficiency of address generation present in CGA. Furthermore, BCA offers both stronger security and improved efficiency compared to CGA.

The original specification of CGA suggests delegating the expensive work done as part of the hash extension technique to a more powerful computer. However, this has the counter-effect of endangering the decentralised nature of the base CGA technique. BCA delegates the expensive part of the work to the blockchain network, thereby preserving the decentralised nature of the base CGA technique.

### 6.1 BCA—General Description

Prior to generating a new BCA, nodes need to register their public key in the blockchain. This is achieved by creating and broadcasting a blockchain transaction tx_{pubKey} that contains a hash of the public key pubKey. Including the full public key is also an option but suffers from lack of privacy. Nodes need to wait for tx_{pubKey} to be included into a block, which takes on average 10 minutes in Bitcoin. It is therefore advised to perform the public key registration in advance, rather than in real time when a new address is needed. Nodes may also register multiple public keys at once to avoid performing the registration process too frequently.

Once the public key is registered in the blockchain in tx_{pubKey}, nodes generate new BCAs using the relevant pieces of information related to tx_{pubKey}. The pieces of information differ depending on the BCA implementation used. Section 6.2 describes a process that uses the block height of tx_{pubKey} and the position of tx_{pubKey} within the block as the interface identifier of the address. Section 6.3 describes a process whereby addresses are generated from the header of the block containing tx_{pubKey} and the identifier of tx_{pubKey}. The security of BCA lies in the fact that the information used to generate an address is computed by the blockchain network and is therefore difficult to produce.

The process of generating and verifying BCAs requires nodes to synchronise and store the chain of block headers. This implies being connected to the blockchain P2P network or to a client able to provide the correct chain of block headers, such as the Block Headers Client in BitcoinSV. Because the chain of block headers grows at a very slow and linear rate (around 4 MB per year in Bitcoin), this process is very lightweight even for low-end nodes. 6.2 BCA—Using the Timestamp Information

This implementation of BCA is to leverage the capability of the blockchain to timestamp information. In this implementation, the location of the transaction tx_{pubKey} that registers pubKey in the blockchain is used as the interface identifier of the address.

The main difference between this BCA implementation and CGA can be seen as follows. In CGA, addresses are randomly generated by hashing a set of parameters comprising pubKey. This randomness is necessary because the domain of the interface identifier is smaller than the public key. Because an attacker can iterate the CGA parameters, spoofing an address is possible. Instead, new addresses can be sequentially generated using the location of tx_{pubKey} in the blockchain. Therefore, the only way to spoof an address is to rewrite the blockchain history to replace tx_{pubkey} with a transaction containing the attacker's public key. As time goes by and blocks are appended to the blockchain, it becomes more difficult for an attacker to rewrite tx_{pubKey} and thus to spoof an address. In Bitcoin SV, it is enough to wait for tx_{pubKey} to be included into a single block to prevent an attacker from rewriting the blockchain with a fraudulent block. Indeed, this malicious behaviour will be detected by the network and the fraudulent block will be discarded.

The process of verifying addresses requires nodes to synchronise and store the chain of block headers. This implies being connected to the blockchain P2P network or to a client able to provide the correct chain of block headers, such as the Block Headers Client in BitcoinSV. Because the chain of block headers grows at a very slow and linear rate (around 4 MB per year in Bitcoin), this process is very lightweight even for low-end nodes.

### 6.2.1 Specification

This subsection describes the processes by which nodes register their public key, generate new addresses, and verify other nodes' addresses.

### 6.2.1.1 Public Key Registration

When nodes register their public key pubKey, they also need to register the subnet prefix subnetPrefix of the address they want to generate. The public key registration process consists in the following steps:
1. Create and broadcast a transaction tx_{pubKey} with one OP_RETURN output containing:
   a hash of pubKey,
   the subnet prefix subnetPrefix,
   any other data items, if needed.
2. Wait for tx_{pubKey} to be included into a block. Additional security can be achieved by waiting for subsequent blocks to be appended after it.
3. Fetch, verify, and persist in memory Π_{Merkle}(tx_{pubKey}), the Merkle proof of inclusion of tx_{pubKey} in the blockchain.

Once these steps are completed, pubKey and subnetPrefix are successfully registered to the blockchain. The proof Π_{Merkle}(tx_{pubKey}) may contain (in addition to the usual Merkle proof information) the following information:
tx_{pubKey}: the full transaction registering pubKey and subnetPrefix.
txIndex_{pubKey}: the index of tx_{pubKey} within the block.
blockHeader_{pubKey}: the header of the block containing tx_{pubKey}.

We denote by blockHeight_{pubKey} the block height encoded in blockHeader_{pubKey}.

### 6.2.1.2 Address Generation

The address generation algorithm takes as input blockHeight_{pubKey}, txIndex_{pubKey}, and subnetPrefix. The algorithm works as follows:
1. Encode blockHeight_{pubKey} as a 23-bit unsigned integer.
2. Encode txIndex_{pubKey} as a 39-bit unsigned integer.
3. Construct the interface identifier by concatenating these two values and inserting two 0 bits at the 6^{th} and 7^{th} position (when starting from 0 from the left). These bits correspond to the u and g bits of the IPv6 address.
4. Concatenate subnetPrefix and the interface identifier to form a 128-bit IPv6 address.

### 6.2.1.3 Address Verification

The address verification algorithm takes as input the IPv6 address, the public key pubKey, and the Merkle proof Π_{Merkle}(tx_{pubKey}). The algorithm works as follows:
1. Extract tx_{pubKey} from Π_{Merkle}(tx_{pubKey}).
2. Hash pubKey and check that the resulting value matches the hashed public key in tx_{pubKey}.
3. Check that subnetPrefix contained in tx_{pubKey} matches the subnet prefix of the address.
4. Verify the Merkle proof Π_{Merkle}(tx_{pubKey}) to confirm the inclusion of tx_{pubKey} in the blockchain.
5. Extract blockHeight_{pubKey} and txIndex_{pubKey} from Π_{Merkle}(tx_{pubKey}).
6. Encode blockHeight_{pubKey} as a 23-bit unsigned integer.
7. Encode txIndex_{pubKey} as a 39-bit unsigned integer.
8. Construct the interface identifier by concatenating these two values and inserting two 0 bits at the 6^{th} and 7^{th} position (when starting from 0 from the left).
9. Verify that the reconstructed interface identifier matches the interface identifier of the address.

If the verification succeeds, then the binding between pubKey and the address is verified.

### 6.2.1.4 Analysis

In this BCA implementation, spoofing an address requires rewriting the blockchain history at the position of tx_{pubKey} with a new transaction containing the attacker's public key. If tx_{pubKey} received at least 6 confirmations, this attack is proven to be economically infeasible. In Bitcoin SV, it is enough to wait for tx_{pubKey} to be included into a block to prevent this attack. A fraudulent block that tries to be added to the blockchain will be detected by the network and discarded.

Contrary to CGA, interface identifiers are generated in-sequence and thus cannot possibly collide with each other. Hence, there is no need to check for an address collision and thus the collision count value of CGA is removed.

Because the blockHeight_{pubKey} value has a fixed size, there will be a point in the future where the maximum value of blockHeight_{pubKey} will be reached. Nevertheless, it will take 150 years to reach this value (the blockHeight_{pubKey} value is encoded in 23 bits and the block time in Bitcoin is 10 minutes), at which point we can expect all of the addresses generated initially to be expired. It will therefore be safe to reuse older blockHeight_{pubKey} values and cycle through them.

The fixed domain of txIndex_{pubKey} also limits the maximum number of addresses that can be generated every second. However, this is not a critical issue because the 39 bits of txIndex_{pubKey} allows nodes to generate 916 million addresses per second, which is more than enough for any reasonable future.

Verifying an address can be performed very efficiently by any lightweight node. The main computational overhead resides in the Merkle proof verification, which only requires performing a logarithmic number of hash computations and comparisons in the number of transactions of the block. The main computational overhead of the address generation is also equivalent to the cost of verifying the Merkle proof.

Although the computational requirement of the address generation is low compared to CGA, its latency remains very high. A single address can be generated from a transaction tx_{pubKey} which prevents nodes from changing their address frequently, therefore creating privacy-related issues. This also means that in case of an address collision, nodes have to go through the process of generating and broadcasting a new transaction in order to generate a new address.

Furthermore, whenever the subnet of a node changes, a new transaction containing the new subnet prefix has to be broadcasted and included in the blockchain. The implication is that a node changing subnet cannot immediately obtain a new address, which makes this technique impractical for some mobile nodes.

### 6.3 BCA—Using the Block Header

This BCA implementation follows more closely the original CGA specification. The difference with CGA stems from the way the binding between the public key and the address is secured. In CGA, the binding is secured by making nodes solve an expensive PoW-like puzzle during address generation. Here, the binding is secured by reusing the header of the block containing tx_{pubKey} that is computed by the blockchain network. Any computationally expensive operation present in CGA is thus removed in this implementation. Moreover, because the work is now done by a highly distributed network of nodes (instead of the conventional machine of a user in CGA), the security of the binding is much stronger.

In this BCA implementation, the block header computed by the blockchain network takes on the role of the modifier value m in CGA. However, the modifier in CGA is not only used to secure the binding but also to enhance privacy by enabling nodes to generate multiple random addresses bound to the same public key. In order to ensure multiple random BCAs bound by the same public key can be generated, multiple randomly generated modifier values should be committed in tx_{pubKey}. One way to achieve this is to construct a Merkle tree of the generated modifier values and include the root of the Merkle tree in tx_{pubKey}. The implication is that once tx_{pubKey} is included in the blockchain, only a fixed number of addresses bound to the public key can be generated. Nodes should therefore make sure to generate and commit to a large number of modifier values. Because the Merkle root has a fixed size, the number of modifier values generated does not have any impact on the size of tx_{pubKey}.

Contrary to the first BCA implementation, the subnet prefix is not registered in the blockchain in tx_{pubKey}. The benefit is that a node that moves from one subnet to another can reuse the already registered public key to generate new addresses. This makes this BCA implementation much more practical for mobile nodes compared to the previous one. Moreover, in this implementation, nodes do not need to synchronise the chain of block headers in order to verify addresses, making the address verification process very lightweight.

Some examples of this BCA implementation also introduce the onchain bit, corresponding to the 4^{th} leftmost bit of the interface identifier. It may be set to 1 if the address is generated from a transaction tx_{pubKey} that has been included in the blockchain 150, and 0 if tx_{pubKey} has not been included in the blockchain 150 yet, or vice versa (see the off-chain examples described below).

### 6.3.1 Specification

This subsection describes the processes by which nodes register their public key, generate new addresses, and verify other nodes' addresses.

### 6.3.1.1 Public Key Registration

The process of registering the public key pubKey and the modifier values is done as follows:
1. Generate a list of N random 128-bit modifier values, N≤2¹⁰ and construct the associated Merkle tree. Persist the modifier values and the associated Merkle tree in memory.
2. Create and broadcast a transaction tx_{pubKey} with one OP_RETURN output containing:
   a hash of pubKey,
   the Merkle root of the previously computed Merkle tree,
   any other data items, if needed.
3. Wait for tx_{pubKey} to be included into a block.
4. Fetch verify and store Π_{Merkle}(tx_{pubKey}), the Merkle proof of inclusion of tx_{pubKey} in the blockchain.

Once these steps are completed, pubKey and the N modifier values are successfully registered in the blockchain. The proof Π_{Merkle}(tx_{pubKey}) may contain (in addition to the usual Merkle proof information) the following information:
tx_{pubKey}: the full transaction registering pubKey and the modifier values.
blockHeader_{pubKey}: the header of the block containing tx_{pubKey}.
The sec parameter for the addresses generated from tx_{pubKey} is derived from the difficulty encoded in the block header. It may be calculated as sec=└ log₂(difficulty)/16┘+2. The minimum sec value is 2 and is obtained when the difficulty of the PoW puzzle is 1. This corresponds to a PoW puzzle whose resolution requires finding a hash in which the leftmost 32 bits are zero. The maximum sec value is 7, which corresponds to a PoW puzzle whose resolution requires finding a hash in which the leftmost 112 bits are zeros. The sec values 0 and 1 are used in the off-chain examples.

### 6.3.1.2 Address Generation

The address generation algorithm takes as input: blockHeader_{pubKey}, tx_{pubKey}, modifier(i), and subnetPrefix. The index i is initialised to zero and is incremented by one every time a new address is generated. The address generation algorithm works as follows:
1. Set an 8-bit collisionCount value to zero.
2. Hash the concatenation of modifier(i), blockHeader_{pubKey}, subnetPrefix, collisionCount, and tx_{pubKey}, and take the 64 leftmost bits of the resulting hash value.
3. Construct the interface identifier from the resulting hash value by writing the sec value into the three leftmost bits, setting the u and g bits (bits 6 and 7 when starting with 0 from the left) to zero, and setting the onchain bit (bit 3) to one.
4. Concatenate subnetPrefix and the interface identifier to form a 128-bit IPv6 address.
5. Perform DAD if required. If an address collision is detected, increment collisionCount by one and go back to step 3. After three collisions, stop and report the error.

Finally, compute Π_{Merkle}(modifier(i)), the Merkle proof of inclusion of the modifier(i) in tx_{pubKey}. The proof contains the full modifier value modifier(i) and is stored in memory.

### 6.3.1.3 Address Verification

The address verification algorithm takes as input the IPv6 address, pubKey, Π_{Merkle}(tx_{pubKey}), subnetPrefix, collisionCount and Π_{Merkle}(modifier(i)). The algorithm works as follows:
1. Check that collisionCount is equal to 0, 1, or 2.
2. Check that subnetPrefix matches the subnet prefix of the address.
3. Check that the height of the Merkle tree corresponding to Π_{Merkle}(tx_{pubKey}) is less than or equal to 32 (there is less than 2³² transactions in the block). If the onchain bit is set to 0, check that the height is 1 (there is a single transaction in the block).
4. Check that the height of the Merkle tree corresponding to Π_{Merkle}(modifier(i)) is less than or equal to 10 (there is less than 2¹⁰ modifiers committed in the transaction). If the onchain bit is set to 0, check that the height is 1 (a single modifier has been committed in the transaction).
5. Extract tx_{pubKey} and blockHeader_{pubKey} from Π_{Merkle}(tx_{pubKey}).
6. Hash pubKey and check that the resulting value matches the hashed public key in tx_{pubKey}.
7. Extract the sec value from the three leftmost bits of the interface identifier of the address.
8. Check that the leftmost 16×sec bits of the hash (double SHA-256) of blockHeader_{pubKey} are zero.
9. Verify the Merkle proof Π_{Merkle}(tx_{pubKey}) to confirm the inclusion of tx_{pubKey} in blockHeader_{pubKey}.
10. Extract modifier(i) from Π_{Merkle}(modifier(i)).
11. Verify the Merkle proof Π_{Merkle}(modifier(i)) to confirm the inclusion of modifier(i) in tx_{pubKey}.
12. Hash the concatenation of modifier(i), blockHeader_{pubKey}, subnetPrefix, collisionCount, and tx_{pubKey}, and check that the 64 leftmost bits of the resulting hash value match the interface identifier of the address. Differences in the sec, onchain, u, and g bits are ignored.

If the verification succeeds, then the binding between pubKey and the address is verified.

### 6.3.1.4 Analysis

In BCA, we make the implicit assumption that the maximum number of transactions that could be included in a block is 2³² (assuming the average transaction size is 500 bytes, this would correspond to a maximum block size of 2.15 TB). Indeed, the verification process fails if the number of transactions in the block is greater than 2³². This is to prevent an attacker from gaining a significant advantage when brute-forcing addresses, as described below.

If we assume the hash function used during address generation to be second pre-image resistant, then spoofing an address can only be done by brute-forcing it. This implies finding and producing a block containing a transaction tx_{pubKey′} that registers the attacker's public key pubKey′ and that is such that:
1. the leftmost 16×sec bits of the hash (double SHA-256) of the block header are zeros,
2. the block header, one of the transactions in the block, and one of the modifiers yield the interface identifier of the target address.

For the attack to be as efficient as possible, the block constructed by the attacker should contain the maximum number of transactions possible, i.e. 2³², each registering pubKey′ and 2¹⁰ modifier values. The total cost for constructing this block is around 2³⁴. Note that the block does not need to be published to the blockchain for the attack to be successful. The first condition is met after performing on average 2^{16×sec+1} hash function evaluations. The second condition is then met with a probability (2³²×2¹⁰)/2⁵⁸=2⁻¹⁶, so this needs to be repeated on average 2¹⁶ times. In total, 2⁵⁸ different inputs have to be tested before a hit with the interface identifier of the target address is found (the second condition is met). This suggests that the number of hash function evaluations and comparison required to spoof/impersonate a specific node is 2⁵⁸+2^{16×sec+17}.

As of January 2023, the difficulty in the three main implementations of Bitcoin (BTC, BCH, and BSV) is such that the sec value is equal to 4, yielding a security of 81 bits. This is 6 more bits than what is achieved in CGA with sec=1. As the hardware speed of machines and in particular Bitcoin miners is expected to increase, so is the sec value.

Another advantage of BCA over CGA is that nodes who want to renew their address do not need to perform any expensive work. In CGA, renewing an address implies redoing the search for a valid modifier value. Because multiple modifier values are committed in tx_{pubKey}, nodes using BCA can renew their address by simply picking another modifier value to be used in the address generation process.

Nodes should make sure to generate a sufficient number of modifier values so as to not run out of values. If it happens that, for e.g. 80% of the modifier values are consumed, nodes may decide to broadcast a new transaction

$${tx}_{pubKey}^{′}$$

containing pubKey and a commit to a different set of modifier values.

Nodes should persist the N modifier values in memory. They should also persist the corresponding Merkle tree to avoid recomputing it every time a new address is generated. If we assume that 2¹⁰ 128-bit modifier values are generated and that the hash digest is of size 256 bits, then only around 81 extra kB have to be stored.

The cost of verifying an address is equivalent to the cost of verifying two Merkle proofs, which is very lightweight. The verification of Π_{Merkle}(tx_{pubKey}) requires a logarithmic number of hash computations and comparisons in the number of transactions of the block, with the maximum being 13. The verification of Π_{Merkle}(modifier(i)) requires a logarithmic number of hash computations and comparisons in the number of modifiers, with the maximum being 11.

The latency of the address generation is relatively high the first time the node generates an address. This is because of the Public Key Registration process, which requires waiting for tx_{pubKey} to be included into a block. However, once the registration is complete, generating addresses in any subnet is fast and requires a single hash computation. A node that wishes to change its public key has to anticipate the fact that a new transaction has to be broadcasted and included into a block before being able to generate new addresses bound to it. However, this does not pose any practical issue because the node can still use addresses bound to the previously registered public key in the meantime.

### 6.3.3 Generalisation to Non-PoW Blockchains

Because the verification process requires nodes to verify that the hash of blockHeader_{pubKey} is less 16×sec (see Step 8 of the address verification process), the previous implementation is only applicable to PoW blockchains. However, this implementation can be generalised to non-PoW blockchain (such as Proof-of-Stake (PoS) blockchains) in the following way. In order to verify an address, nodes have to first synchronise the chain of block headers. In Step 7, they instead check that the block headers are present in the synchronised chain. The Public Key Registration and Address Generation processes remain the same (except that the sec bits are not used).

### 6.4 Off-Chain Quick Address Generation

One limitation with the previous implementation is the high latency of the public key registration process which prevents newly set-up nodes from quickly generating new addresses; this is against the plug-and-play capability of IPv6. Moreover, it might not necessarily be the case that the node already has a connection to the blockchain network when generating a BCA.

To address this limitation, instead of waiting for tx_{pubKey} to be included in the blockchain in order to generate new addresses, nodes may use the transaction identifier of tx_{pubKey} to immediately generate new addresses. The transaction tx_{pubKey} contains a hash of pubKey and a hash of a randomly generated modifier value.

The address generation algorithm takes as input: tx_{pubKey}, modifier, subnetPrefix, and the security parameter sec. The algorithm works as follows:
1. Create a block containing tx_{pubKey}. Set all the parameters of the block header blockHeader_{pubKey} (except the Merkle root) to zero.
2. Iterate the parameters of the block header until the leftmost 16×sec bits of the hash of the block header are zero.
3. Set an 8-bit collisionCount value to zero.
4. Hash the concatenation of modifier, subnetPrefix, collisionCount, and tx_{pubKey}, and take the 64 leftmost bits of the resulting hash value.
5. Construct the interface identifier from the resulting hash value by writing the sec value into the three leftmost bits, setting the u and g bits (bits 6 and 7 when starting with 0 from the left) to zero, and setting the onchain bit (bit 3) to zero.
6. Concatenate subnetPrefix and the interface identifier to form a 128-bit IPv6 address.
7. Perform DAD if required. If an address collision is detected, increment collisionCount by one and go back to step 3. After three collisions, stop and report the error.

The Merkle tree of modifiers and the Merkle tree of transactions both have a height equal to one. The verification procedure in off-chain BCA is the same as in BCA, making both techniques naturally compatible.

In off-chain BCA, hosts perform the search for a valid block header themselves instead of delegating this work to blockchain nodes 104. This allows hosts to quickly obtain a new address if they have not yet registered their public key to the blockchain. Similar to CGA, the difficulty of the work is chosen by hosts depending on their computational capacity. The higher the difficulty, the higher the security of the binding but the more resource it takes to generate an address. Whenever a connection to the blockchain is found, hosts should register their public key and use the standard BCA technique to efficiently generate secure addresses. The off-Chain Quick Address Generation technique can be integrated with (on-chain) BCA so that nodes can quickly and efficiently generate secure IPv6 addresses. The process is as follows:
1. Create a transaction tx_{pubKey} registering pubKey and a randomly generated modifier value.
2. Generate IPv6 addresses using the Quick Address Generation technique.
3. Whenever a connection with the blockchain network is established, create a new transaction

$${tx}_{pubKey}^{′}$$

registering pubKey and N modifier values and broadcast it to the blockchain network.
4. When tx_{pubKey} is included into a block, generate IPv6 addresses with stronger security using the (on-chain) BCA technique.

### 6.5 BCA—Extensions

### 6.5.1 Public Key Revocation

An extension to BCA involves adding another P2PKH output to tx_{pubKey} and using the status of this output (spent vs. unspent) as an indicator of the validity of pubKey. An address is valid if and only if the P2PKH output in tx_{pubKey} is unspent. If pubKey happens to be compromised by an attacker, the node may spend the output, thereby preventing the attacker from using the associated address. Note that it is also an option to make the output containing pubKey spendable and spending it in order to revoke pubKey.

### 6.5.2 Authentication

BCA gives the flexibility to include any additional data to be stored immutably in the blockchain. For example, a signature done with the private key corresponding to pubKey can be included in tx_{pubKey} to add authentication directly in the address verification process. In this case, BCA would not only guarantee the binding between the public key and the address, but also that the node actually controls the public key.

As an option, the node can add a signature signing the first outpoint of tx_{pubKey} in the OP_RETURN data of tx_{pubKey}. In order to verify that the node controls pubKey, the address verification algorithm should include an extra step that verifies the signature included in tx_{pubKey}.

Another option involves leveraging the signature verification process done by the blockchain network as part of the transaction validation process. This can be done by using a P2PKH script inside tx_{pubKey} to lock it to pubKey. In addition to broadcasting tx_{pubKey} during public key registration, the node should broadcast another transaction txUnlock_{pubKey} unlocking tx_{pubKey} to prove control of pubKey. The Merkle proof of txUnlock_{pubKey} should be communicated during the address verification procedure so as to prove that the transaction has been included in the blockchain and that therefore the node controls pubKey. This method implies broadcasting two transactions instead of one during public key registration but adds authenticity check in BCA without doing any expensive signature verification during address verification.

One limitation of this method is that the signature scheme is fixed by the blockchain protocol (ECDSA with the Secp256k1 curve in Bitcoin). In order to make the previous method applicable to additional curves and signature schemes, the P2PKH script can be replaced by a pay-to-any-public-key (P2APK) script, as described in UK patent application GB2206040.4. The public key registration, address generation, and address verification process are done in the same way as before.

### 6.5.3 Alternative Address Renewal

In Section 6.2, addresses can be renewed by broadcasting a new transaction

$${tx}_{pubKey}^{′}$$

and recording the position of

$${tx}_{pubKey}^{′}$$

in the blockchain. In Section 6.3, addresses can be renewed by selecting a different modifier modifierⱼ in the list of generated modifiers. An alternative option involves making the output containing pubKey spendable and spending it with a new transaction

$${tx}_{pubKey}^{′}$$

registering pubKey again. The address is renewed by using the new blockchain information related to

$${tx}_{pubKey}^{′} ,$$

i.e. the position of

$${tx}_{pubKey}^{′}$$

in the first implementation or the associated block header in the second implementation. The advantage is that we now have a chain of spent transactions, and therefore a provable link between IPv6 addresses generated from the same public key pubKey.

### 7. Further Remarks

Other variants or use cases of the disclosed techniques may become apparent to the person skilled in the art once given the disclosure herein. The scope of the disclosure is not limited by the described embodiments but only by the accompanying claims.

For instance, some embodiments above have been described in terms of a bitcoin network 106, bitcoin blockchain 150 and bitcoin nodes 104. However it will be appreciated that the bitcoin blockchain is one particular example of a blockchain 150 and the above description may apply generally to any blockchain. That is, the present invention is in by no way limited to the bitcoin blockchain. More generally, any reference above to bitcoin network 106, bitcoin blockchain 150 and bitcoin nodes 104 may be replaced with reference to a blockchain network 106, blockchain 150 and blockchain node 104 respectively. The blockchain, blockchain network and/or blockchain nodes may share some or all of the described properties of the bitcoin blockchain 150, bitcoin network 106 and bitcoin nodes 104 as described above.

In preferred embodiments of the invention, the blockchain network 106 is the bitcoin network and bitcoin nodes 104 perform at least all of the described functions of creating, publishing, propagating and storing blocks 151 of the blockchain 150. It is not excluded that there may be other network entities (or network elements) that only perform one or some but not all of these functions. That is, a network entity may perform the function of propagating and/or storing blocks without creating and publishing blocks (recall that these entities are not considered nodes of the preferred bitcoin network 106).

In other embodiments of the invention, the blockchain network 106 may not be the bitcoin network. In these embodiments, it is not excluded that a node may perform at least one or some but not all of the functions of creating, publishing, propagating and storing blocks 151 of the blockchain 150. For instance, on those other blockchain networks a “node” may be used to refer to a network entity that is configured to create and publish blocks 151 but not store and/or propagate those blocks 151 to other nodes.

Even more generally, any reference to the term “bitcoin node” 104 above may be replaced with the term “network entity” or “network element”, wherein such an entity/element is configured to perform some or all of the roles of creating, publishing, propagating and storing blocks. The functions of such a network entity/element may be implemented in hardware in the same way described above with reference to a blockchain node 104.

Some embodiments have been described in terms of the blockchain network implementing a proof-of-work consensus mechanism to secure the underlying blockchain. However proof-of-work is just one type of consensus mechanism and in general embodiments may use any type of suitable consensus mechanism such as, for example, proof-of-stake, delegated proof-of-stake, proof-of-capacity, or proof-of-elapsed time. As a particular example, proof-of-stake uses a randomized process to determine which blockchain node 104 is given the opportunity to produce the next block 151. The chosen node is often referred to as a validator. Blockchain nodes can lock up their tokens for a certain time in order to have the chance of becoming a validator. Generally, the node who locks the biggest stake for the longest period of time has the best chance of becoming the next validator.

It will be appreciated that the above embodiments have been described by way of example only. More generally there may be provided a method, apparatus or program in accordance with any one or more of the following Statements.

Statement 1. A computer-implemented method of generating a network address, wherein the method comprises:
generating a first blockchain transaction, wherein the first transaction comprises a first data item based on a public key; and
generating a first network address based on one or more second data items related to the first blockchain transaction.

The public key is associated with a first party. The method may be performed by the first party or a different party.

The first data item may comprise the public key and/or be generated as a function of the public key.

Statement 2. The method of statement 1, wherein the first data item comprises a hash of at least the public key.

Statement 3. The method of statement 1 or statement 2, wherein the one or more second data items comprise a transaction identifier of the first blockchain transaction.

Statement 4. The method of statement 3, wherein the first network address is generated prior to the first blockchain transaction being recorded on the blockchain.

Statement 5. The method of any of statements 1 to 3, comprising:
causing the first blockchain transaction to be submitted to a blockchain network for being recorded on the blockchain.

Statement 6. The method of statement 5, wherein one or more of the second data items are related to a location of the first blockchain transaction in the blockchain.

Statement 7. The method of statement 6, wherein the one or more second data items comprise a block height of the first block and a transaction index, wherein the transaction index indicates a position of the first blockchain transaction in the first block.

Statement 8. The method of any of statements 5 to 7, wherein the one or more second data items comprise a block header of the first block and a transaction identifier of the first blockchain transaction.

Statement 9. The method of any preceding statement, wherein the first network address is based on a first modifier value.

Statement 10. The method of statement 9, comprising:
generating a plurality of modifier values, wherein the plurality of modifier values comprises the first modifier value; and
generating a third data item that encodes the plurality of modifier values, wherein the first blockchain transaction comprises the third data item.

Statement 11. The method of statement 10, wherein a total number of modifier values is less than or equal to a predetermined maximum value. The predetermined maximum value may be 2¹⁰.

Statement 12. The method of any preceding statement, wherein the first network address comprises a network prefix.

Statement 13. The method of statement 12, wherein the first blockchain transaction comprises the network prefix.

Statement 14. The method of any preceding statement, wherein the network address is an internet protocol version 6, IPv6, address.

Statement 15. The method of statement 14 when dependent on statements 3 and 12, wherein said generating of the first network address comprises:
generating a hash of a concatenation of the first modifier value, the block header, the transaction identifier, the network prefix and a collision count value;
constructing an interface identifier by extracting a leftmost 64 bits of the hash and inserting two additional bits at the 6^{th} and 7^{th} bit positions; and concatenating the network prefix and the interface identifier.

Statement 16. The method of statement 14 when dependent on statements 3 and 12, wherein said generating of the first network address comprises:
constructing a block comprising the first transaction and a block header of the block, wherein the block header comprises a plurality of parameters, wherein the plurality of parameters includes a Merkle root generated based on the first transaction;
setting each of the parameters of the block header to zero, except for the Merkle root;
iterating the parameters of the block header until the leftmost 16×sec bits of a hash of the block header are zero, wherein sec is a security parameter;
generating a hash of a concatenation of the first modifier value, the block header, the transaction identifier, the network prefix and a collision count value;
constructing an interface identifier by extracting a leftmost 64 bits of the hash, replacing the three leftmost bits of the hash with the security parameter, and inserting two additional bits at the 6^{th} and 7^{th} bit positions; and
concatenating the network prefix and the interface identifier.

Statement 17. The method of statement 14 when dependent on statements 7 and 12, wherein said generating of the first network address comprises:
encoding the block height as an n-bit unsigned integer;
encoding the transaction index as an m-bit unsigned integer, wherein n+m=62;
constructing an interface identifier by concatenating the n-bit unsigned integer and the m-bit unsigned integer and inserting two additional bits at the 6th and 7th bit positions; and
concatenating the network prefix and the interface identifier.

Statement 18. The method of any of statements 15 to 17, wherein the two additional bits are set as 0.

Statement 19. The method of statement 18, wherein said constructing of the interface identifier comprises replacing the three leftmost bits of the hash with a security parameter, wherein the security parameter is based on a difficulty value encoded in the block header.

Statement 20. The method of statement 19, wherein the security value, sec, is calculated as sec=└ log₂(difficulty)/16┘+2.

Statement 21. The method of any of statements 15 to 20, wherein the interface identifier comprises a bit indicating whether the first network address is generated based on a transaction that has been included in the blockchain.

Statement 22. The method of any preceding statement, comprising waiting until at least a predetermined number of subsequent blocks have been added to the blockchain after the first block before generating the first network address.

Statement 23. The method of any preceding statement, comprising making the first network address available to one or more parties.

Statement 24. The method of any preceding statement, comprising:
obtaining a first proof that the first blockchain transaction is recorded in the blockchain; and
sending the first proof to a verifier for verifying the first network address.

Statement 25. The method of statement 24 when dependent on statement 10, comprising:
obtaining a second proof that the third data item encodes the first modifier value; and
sending the second proof to a verifier for verifying the first network address.

Statement 26. The method of any preceding statement, wherein the first blockchain transaction comprises a signature generated using a private key corresponding to the public key.

Statement 27. The method of any preceding statement, wherein the first blockchain transaction comprises an output locked to the public key, and wherein the method comprises:
causing a second blockchain transaction to be submitted to the blockchain network, wherein the second blockchain transaction comprises an input that references the output of the first blockchain transaction and comprises a signature generating using a private key corresponding to the public key and configured to unlock the output.

Statement 28. The method of statement 27, comprising:
obtaining a third proof that the second blockchain transaction is recorded in the blockchain; and
sending the third proof to a verifier for verifying the first network address.

Statement 29. The method of any preceding statement when dependent on statement 4 and statement 5, comprising:
after the first blockchain transaction has been recorded in the first block of the blockchain, generating a second network address based on one or more second data items related to the first blockchain transaction, wherein at least one of the one or more second data items is related to the location of the first blockchain transaction in the blockchain.

Statement 30. A computer-implemented method of verifying a network address, wherein the method comprises:
obtaining a target public key, a target network address, and a first blockchain transaction comprising a first data item;
verifying that the first data item is based on the target public key;
obtaining one or more second data items related to the first blockchain transaction; generating a candidate network address based on the one or more second data items; and
verifying that the target network address matches the candidate network address.

Statement 31. The method of statement 30, comprising:
obtaining a first proof that the first blockchain transaction is recorded in the blockchain; and
using the first proof to verify that the first blockchain transaction is recorded in the blockchain.

Statement 32. The method of statement 30 or statement 31, comprising:
obtaining a candidate first modifier value; and
generating the candidate network address based on the candidate first modifier value.

Statement 33. The method of statement 32, wherein the first blockchain transaction comprises a third data item encoding a plurality of modifier values, and wherein the method comprises:
obtaining a second proof that the third data item encodes the first modifier value; and
using the second proof to verify that the third data item encodes the first modifier value.

Statement 34. The method of any of statements 30 to 33, comprising:
verifying that the first blockchain transaction comprises a signature corresponding to the public key.

Statement 35. The method of any of statements 31 to 34, wherein the first blockchain transaction comprises an output locked to the public key, and wherein the method comprises:
obtaining a second blockchain transaction comprising an input that references the output of the first blockchain transaction and comprising a signature configured to unlock the output;
obtaining a third proof that the second blockchain transaction is recorded in the blockchain; and
using the third proof to verify that the second blockchain transaction is recorded in the blockchain.

Statement 36. The method of statement 31 or any statement dependent thereon, comprising:
using the first proof to verify that there are no more than 2³² transactions in a block containing the first blockchain transaction.

Statement 37. The method of statement 33 or any statement dependent thereon, comprising:
using the second proof to verify that the plurality of modifier values comprises no more than 2\hat{ }10 modifier values.

Statement 38. The method of statement 31, wherein the first blockchain transaction has not been recorded on the blockchain.

Statement 39. The method of statement 38, comprising:
obtaining a block comprising the first blockchain transaction; and
verifying that the block comprises only one blockchain transaction.

Statement 40. The method of statement 38 or statement 39 when dependent on statement 33, comprising:
verifying that the first blockchain transaction comprises a commitment to only one modifier value.

Statement 41. The method of statement 38 or any statement dependent thereon, wherein the target network address comprises a security value comprising sec bits, and wherein the method comprises:
verifying that the leftmost 16×sec bits of a hash of a block header of the block comprising the first blockchain transaction are zero.

Statement 42. Computer equipment comprising:
memory comprising one or more memory units; and
processing apparatus comprising one or more processing units, wherein the memory stores code arranged to run on the processing apparatus, the code being configured so as when on the processing apparatus to perform the method of any of statements 1 to 41.

Statement 43. A computer program embodied on computer-readable storage and configured so as, when run on one or more processors, to perform the

[symbol]

1. A computer-implemented method of generating a network address, wherein the method comprises:
generating a first blockchain transaction, wherein the first transaction comprises a first data item based on a public key; and
generating a first network address based on one or more second data items related to the first blockchain transaction.

2. The method of claim 1, wherein the first data item comprises a hash of at least the public key.

3. The method of claim 1, wherein the one or more second data items comprise a transaction identifier of the first blockchain transaction.

4. The method of claim 3, wherein the first network address is generated prior to the first blockchain transaction being recorded on the blockchain.

5. The method ofany of claim 1, comprising:
causing the first blockchain transaction to be submitted to a blockchain network for being recorded on the blockchain.

6. The method of claim 5, wherein one or more of the second data items are related to a location of the first blockchain transaction in the blockchain.

7. The method of claim 6, wherein the one or more second data items comprise a block height of a first block and a transaction index, wherein the transaction index indicates a position of the first blockchain transaction in the first block.

8. The method of claim 5, wherein the one or more second data items comprise a block header of a first block and a transaction identifier of the first blockchain transaction.

9. The method of claim 1, wherein the first network address is also based on a first modifier value.

10. The method of claim 9, comprising:
generating a plurality of modifier values, wherein the plurality of modifier values comprises the first modifier value; and
generating a third data item that encodes the plurality of modifier values, wherein the first blockchain transaction comprises the third data item.

11. (canceled)

12. The method of claim 1, wherein the first network address comprises a network prefix.

13. (canceled)

14. The method of claim 1, wherein the network address is an internet protocol version 6, IPv6, address.

15-21. (canceled)

22. The method of claim 1, comprising waiting until at least a predetermined number of subsequent blocks have been added to the blockchain after a first block before generating the first network address.

23. The method of claim 1, comprising making the first network address available to one or more parties.

24. The method of claim 1, comprising:
obtaining a first proof that the first blockchain transaction is recorded in the blockchain; and
sending the first proof to a verifier for verifying the first network address.

25. (canceled)

26. The method of claim 1, wherein the first blockchain transaction comprises a signature generated using a private key corresponding to the public key.

27. The method of claim 1, wherein the first blockchain transaction comprises an output locked to the public key, and wherein the method comprises:
causing a second blockchain transaction to be submitted to the blockchain network, wherein the second blockchain transaction comprises an input that references the output of the first blockchain transaction and comprises a signature generating using a private key corresponding to the public key and configured to unlock the output.

28. The method of claim 27, comprising:
obtaining a third proof that the second blockchain transaction is recorded in the blockchain; and
sending the third proof to a verifier for verifying the first network address.

29-41. (canceled)

42. Computer equipment comprising:
memory comprising one or more memory units; and
processing apparatus comprising one or more processing units, wherein the memory stores code arranged to run on the processing apparatus, the code being configured so as when run on the processing apparatus, the processing apparatus performs a method of generating a network address, wherein the method comprises:
generating a first blockchain transaction, wherein the first transaction comprises a first data item based on a public key; and
generating a first network address based on one or more second data items related to the first blockchain transaction.

43. A non-transitory computer readable medium comprising a computer program that is configured so as, when run on one or more processors, the one or more processors perform a method of any of generating a network address, wherein the method comprises:
generating a first blockchain transaction, wherein the first transaction comprises a first data item based on a public key; and
generating a first network address based on one or more second data items related to the first blockchain transaction.
